(19) United States
(12) Patent Application Publication
(10) Pub. No.: US 2023/0131694 A1
(43) Pub. Date: Apr. 27, 2023

(54) SYSTEMS, METHODS, AND APPARATUS FOR ARTIFICIAL INTELLIGENCE AND MACHINE LEARNING FOR A PHYSICAL LAYER OF COMMUNICATION SYSTEM

(71) Applicant: Samsung Electronics Co., Ltd., Suwon-si (KR)

(72) Inventors: Hamid SABER, San Diego, CA (US); Mohammed KARMOOSE, San Diego, CA (US); Jung Hyun BAE, San Diego, CA (US); Yuansheng CHENG, San Diego, CA (US); HyukJoon KWON, San Diego, CA (US)

(21) Appl. No.: 17/959,291

(22) Filed: Oct. 3, 2022

Related U.S. Application Data
(60) Provisional application No. 63/257,559, filed on Oct. 19, 2021.
(60) Provisional application No. 63/289,138, filed on Dec. 13, 2021.
(60) Provisional application No. 63/298,620, filed on Jan. 11, 2022.
(60) Provisional application No. 63/325,145, filed on Mar. 29, 2022.
(60) Provisional application No. 63/325,607, filed on Mar. 30, 2022.
(60) Provisional application No. 63/331,693, filed on Apr. 15, 2022.
(60) Provisional application No. 63/390,273, filed on Jul. 18, 2022.

(51) Int. Cl. G06N 3/08; H04W 24/08

(52) U.S. Cl. CPC G06N 3/08; H04W 24/08

(57) ABSTRACT

An apparatus may include a receiver configured to receive a signal using a channel, a transmitter configured to transmit a representation of channel information relating to the channel, and at least one processor configured to determine a condition of the channel based on the signal, and generate the representation of the channel information based on the condition of the channel using a machine learning model. A method may include determining, at a wireless apparatus, physical layer information for the wireless apparatus, generating a representation of the physical layer information using a machine learning model, and transmitting, from the wireless apparatus, the representation of the physical layer information.

### CROSS-REFERENCE TO RELATED APPLICATIONS

This application claims priority to, and the benefit of, U.S. Provisional Patent Application Ser. No. 63/257,559 filed Oct. 19, 2021; Ser. No. 63/289,138 filed Dec. 13, 2021; Ser. No. 63/298,620 filed Jan. 11, 2022; Ser. No. 63/325,145 filed Mar. 29, 2022; Ser. No. 63/325,607 filed Mar. 30, 2022; Ser. No. 63/331,693 filed Apr. 15, 2022; and Ser. No. 63/390,273 filed Jul. 18, 2022 all of which are incorporated by reference.

### TECHNICAL AREA

This disclosure relates generally to communication systems and specifically to systems, methods, and apparatus for artificial intelligence and machine learning for a physical layer of a communication system.

### BACKGROUND

In a wireless communication system, a receiver may provide channel state information or precoding information to a transmitter based on channel conditions between the transmitter and the receiver. The transmitter may use the channel state information or precoding information to perform transmissions to the receiver.

The above information disclosed in this Background section is only for enhancement of understanding of the background of the invention and therefore it may contain information that does not constitute prior art.

### SUMMARY

An apparatus may include a receiver configured to receive a signal using a channel, a transmitter configured to transmit a representation of channel information relating to the channel, and at least one processor configured to determine a condition of the channel based on the signal, and generate the representation of the channel information based on the condition of the channel using a machine learning model. The channel information may include a channel estimation. The channel information may include precoding information. The at least one processor may be configured to perform a selection of the machine learning model. The at least one processor may be configured to perform the selection of the machine learning model based on the condition of the channel. The at least one processor may be configured to activate the machine learning model based on model identification information received using the receiver. The apparatus may be configured to receive the model identification information using one or more of a media access control (MAC) signal or a radio resource control (RRC) signal. The at least one processor may be configured to indicate the selection of the machine learning model using the transmitter. The at least one processor may be configured to receive the machine learning model. The at least one processor may be configured to receive a quantization function corresponding to the machine learning model. The at least one processor may be configured to train the machine learning model. The at least one processor may be configured to train the machine learning model using a quantization function. The quantization function may include a differentiable quantization function. The quantization function may include an approximated quantization function. The at least one processor may be configured to send configuration information for the machine learning model. The configuration information may include one or more or a weight or a hyperparameter. The machine learning model may be a generation model, and the at least one processor may be configured to train the generation model using a reconstruction model that may be configured to reconstruct the channel information based on the representation. The generation model may include an encoder, and the reconstruction model may include a decoder. The at least one processor may be configured to receive configuration information for the reconstruction model, and train the generation model based on the configuration information. The configuration information may include one or more or a weight or a hyperparameter. The at least one processor may be configured to perform joint training of the generation model and the reconstruction model. The at least one processor may be configured to send the reconstruction model based on the joint training. The at least one processor may be configured to collect training data for the machine learning model based on the channel. The at least one processor may be configured to collect the training data based on a resource window. The resource window has a time dimension and a frequency dimension. The channel information may include a channel matrix. The channel information may include a singular value matrix combined with a singular value. The channel information may include a unitary matrix. The at least one processor may be configured to preprocess the channel information to generate transformed channel information, and generate the representation of the channel information based on the transformed channel information. The at least one processor may be configured to preprocess the channel information based on a transformation, and train the machine learning model based on training data, wherein the training data may be processed based on the transformation. The at least one processor may be configured to process the training data based on the transformation. The at least one processor may be configured to train the machine learning model using a processing allowance. The processing allowance may include a processing time. The processing allowance may be initiated based on the signal. The processing allowance may be initiated based on a control signal. The control signal may include one or more of a media access control (MAC) signal or a radio resource control (RRC) signal. The at least one processor may be configured to send the representation of the channel information as link control information. The at least one processor may be configured to send the link control information as uplink control information (UCI). The at least one processor may be configured to quantize the representation of the channel information to generate a quantized representation. The at least one processor may be configured to and apply a coding scheme to the quantized representation to generate a coded representation. The coding scheme may include a polar coding scheme, and the at least one processor may be configured to send the coded representation using a physical control channel. The coding scheme may include a low-density parity-check (LDPC) coding scheme, and the at least one processor may be configured to send the coded representation using a physical shared channel.

An apparatus may include a transmitter configured to send a signal using a channel, a receiver configured to receive a representation of channel information relating to the channel, and at least one processor configured to construct the channel information based on the representation using a machine learning model. The machine learning model may be a reconstruction model, and the at least one processor may be configured to train the reconstruction model using a generation model that may be configured to generate the representation of the channel information. The at least one processor may be configured to send the machine learning model. The at least one processor may be configured to send a dequantizing function corresponding to the machine learning model. The representation of the channel information may include a representation of transformed channel information, and the at least one processor may be configured to postprocess an output of the machine learning model to construct the channel information based on the transformed channel information. The representation of transformed channel information may be based on a transformation, the machine learning model may be a reconstruction model, the at least one processor may be configured to train the reconstruction model using a generation model that may be configured to generate the representation of the transformed channel information, and the at least one processor may be configured to train the reconstruction model using training data that may be processed based on the transformation. The at least one processor may be configured to perform a selection of the machine learning model, and indicate the selection of the machine learning model using the transmitter.

A method may include determining, at a wireless apparatus, physical layer information for the wireless apparatus, generating a representation of the physical layer information using a machine learning model, and transmitting, from the wireless apparatus, the representation of the physical layer information. The machine learning model may be a generation model, the method further comprising training the generation model using a reconstruction model that may be configured to reconstruct the physical layer information based on the representation. The method may further include collecting, by the wireless apparatus, training data for the machine learning model based on a resource window. The physical layer information may include a channel matrix. The method may further include preprocessing the physical layer information to generate transformed physical layer information, and generating the representation of the physical layer information based on the transformed physical layer information. The generating may be performed based on a processing allowance. The method may further include activating the machine learning model based on model identification information received at the wireless apparatus. The representation of the physical layer information may include uplink control information.

### BRIEF DESCRIPTION OF THE DRAWINGS

The figures are not necessarily drawn to scale and elements of similar structures or functions are generally represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawing from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates an embodiment of a wireless communication apparatus according to the disclosure.

FIG. 2 illustrates another embodiment of a wireless communication apparatus according to the disclosure.

FIG. 3 illustrates an embodiment of a two-model training scheme according to the disclosure.

FIG. 4 illustrates an embodiment of a system having a pair of models to provide channel information feedback according to the disclosure.

FIG. 5 illustrates an example embodiment of a system for reporting downlink physical layer information according to the disclosure.

FIG. 6 illustrates an example embodiment of a system for reporting uplink physical layer information according to the disclosure.

FIG. 7 illustrates an example embodiment of a system for reporting downlink physical layer channel state information according to the disclosure.

FIG. 8 illustrates an embodiment of a learning process for a machine learning model according to the disclosure.

FIG. 9 illustrates an example embodiment of a method for joint training of a pair of encoder and decoder models according to the disclosure.

FIG. 10 illustrates an example embodiment of a method for training models with latest shared values according to the disclosure.

FIG. 11 illustrates an example embodiment of a two-model training scheme with pre-processing and post-processing according to the disclosure.

FIG. 12 illustrates an embodiment of a system for using a two-model scheme according to the disclosure.

FIG. 13 illustrates an example embodiment of a user equipment (UE) in accordance with the disclosure.

FIG. 14 illustrates an example embodiment of a base station in accordance with the disclosure.

FIG. 15 illustrates an embodiment of a method for providing physical layer information feedback in accordance with the disclosure.

### DETAILED DESCRIPTION

### Overview

In some wireless communication systems, a transmitting device may rely on a receiving device to provide feedback information on channel conditions to enable the transmitting device to transmit more effectively to the receiving device through the channel. For example, in a 5G New Radio (NR) system, a base station (e.g., a gNodeB or gNB) may send a reference signal to a user equipment (UE) through a downlink (DL) channel. The UE may measure the reference signal to determine channel conditions on the DL channel. The UE may then send feedback information (e.g., channel state information (CSI)) indicating the channel conditions on the DL channel to the base station through an uplink (UL) channel. The base station may use the feedback information to improve the manner in which it transmits to the UE through the DL channel, for example, through the use of beamforming.

Sending feedback information on channel conditions, however, may consume a relatively large amount of resources as overhead. To reduce the amount of data used to transmit feedback information, some wireless communication systems may use one or more types of codebooks to enable a receiving device to send implicit and/or explicit channel condition feedback to a transmitting device. For example, in 5G NR systems, a Type-I codebook may be used to provide implicit CSI feedback to a gNB in the form of an index that may point to a predefined precoding matrix indicator (PMI) selected by the UE based on the DL channel conditions. The gNB may then use the PMI for beamforming in the DL channel. As another example, a Type-II codebook may be used to provide explicit CSI feedback in which a UE may derive a PMI that may be fed back to the gNB which may use the PMI for beamforming in the DL channel. The use of a Type-I codebook, however, may not provide CSI feedback with adequate accuracy. Moreover, the use of a Type-II codebook may still involve the transmission of a significant amount of overhead data on a UL channel.

A feedback scheme in accordance with the disclosure may use artificial intelligence (AI), machine learning (ML), deep learning, and/or the like (any or all of which may be referred to individually and/or collectively as machine learning or ML) to generate a representation of physical layer information for a wireless communication system. For example, in some embodiments, a feedback scheme may use an ML model to generate a representation of feedback information for a channel condition (e.g., a representation of a channel matrix, a precoding matrix, and/or the like). The representation may be a compressed, encoded, or otherwise modified form of the feedback information which, depending on the implementation details, may reduce the resources involved in transmitting the feedback information between apparatus.

A feedback scheme in accordance with the disclosure may also use machine learning to reconstruct the physical layer information from the representation. For example, in some embodiments, a feedback scheme may use an ML model to reconstruct feedback information, or an approximation of the feedback information, from a representation of the feedback information for a channel condition. For convenience, an ML model may be referred to simply as a model.

A model that generates a representation of an input (e.g., physical layer information such as feedback information for a channel condition) may be referred to as a generation model. A model that reconstructs an input, or an approximation of the input, from a representation of the input may be referred to as a reconstruction model. An output of a reconstruction model may be referred to as a reconstructed input. Thus, a reconstructed input may be the input applied to the generation model, or an approximation, estimate, prediction, etc., of the input applied to the generation model. A generation model and a corresponding reconstruction model may be referred to collectively as a pair of ML models or a pair of models. In some embodiments, a generation model may be implemented as an encoder model, and/or a reconstruction model may be implemented as a decoder model. Thus, an encoder model and a decoder model may also be referred to as a pair of ML models or a pair of models.

Any model may be referred to as a first model, a second model, Model A, Model B, and/or the like for purposes of distinguishing the model from one or more other models, and the label used for the model is not intended to imply the type of model unless otherwise apparent from context. For instance, in the context of a pair of models, if Model A refers to a generation model, Model B may refer to a reconstruction model.

A node may refer to a base station, a UE, or any other apparatus that may use one or more ML models as disclosed herein. Additional examples of nodes may include a UE side server, a based station side server (e.g., a gNB side server), an eNodeB, a master node, a secondary node, and/or the like, whether logical nodes, physical nodes, or a combination thereof. Any node may be referred to as a first node, a second node, Node A, Node B, and/or the like for purposes of distinguishing the node from one or more other nodes, and the label used for the node is not intended to imply the type of node unless otherwise apparent from context. For example, in some embodiments, a first node may refer to a UE and a second node may refer to a base station. In some other embodiments, however, a first node may refer to a first UE and a second node may refer to a second UE configured for sidelink communications with the first UE.

In some example embodiments, a first node may use a first model (e.g., a generation model) to encode a channel matrix, a precoding matrix, and/or the like, to generate a feature vector that may be transmitted to a second node. A second node may use a second model (e.g., a reconstruction model) to decode the feature vector to reconstruct the original information (e.g., the channel matrix, precoding matrix, and/or the like) or an approximation of the original information.

Some embodiments in accordance with the disclosure may implement a two-model training scheme in which models may be trained in pairs. For example, a reconstruction model may be used to train a generation model, and/or a generation model may be used to train a reconstruction model. In some example implementations, a pair of models may be configured to implement an auto-encoder in which an encoder model (e.g., for a first node) may be trained with a decoder model (e.g., for a second node).

In some embodiments, a first model (e.g., a generation model) that may be used for inference by a first node may be trained using a second model (e.g., a reconstruction model) that may actually be used for inference by a second node. The training may be performed by the first node, the second node, and/or any other apparatus, for example, by a server that may train the models (e.g., offline) and transfer one or more of the trained models to one or more of the nodes to use for inference.

Alternatively, or additionally, the first model may be trained using a second model that may provide some amount of matching between the first model and the second model, even if the second model is not the actual model that may be used for inference by the second node. Alternatively, or additionally, the first model may be trained using a reference model for the second model. Alternatively, or additionally, the first model may be trained using a second model that may be configured with values of weights, hyperparameters, and/or the like that may be initialized to predetermined values, randomized values, and/or the like.

In some embodiments, a pair of models may be trained simultaneously, sequentially (e.g., alternating between training a first model while freezing a second model, then training the second model while freezing the first model), and/or the like using the same or different training data sets.

In some embodiments, a node may use a quantizer to convert a representation of physical layer information to a form that may be more readily transmitted through a communication channel. For example, a quantizer may convert a real number (e.g., an integer) representation of physical layer information to a binary bit stream that may then be applied to a polar encoder or other apparatus for transmission through a physical uplink or downlink channel. Similarly, a node may use a dequantizer to convert a bit stream to a representation of physical layer information that may be used to reconstruct the physical layer information. In some embodiments, a quantizer or dequantizer may be considered part of an ML model. For example, a generation model may include an encoder and a corresponding quantizer, and/or a reconstruction model may include a corresponding dequantizer.

Some embodiments in accordance with the disclosure may implement one or more frameworks for training models and/or transferring models between nodes. For example, in a first type of framework, a first node (Node A) may jointly train a pair of models (Model A and Model B). Node A may use the trained Model A for inference and transfer the trained Model B to a second node (Node B) which may use the trained Model B for inference. In a variation of the first type of framework, Node A may transfer the trained Model A to Node B, and Node B may use the trained Model A to train its own Model B to use for inference.

In a second type of framework, a reference model may be established as Model A for a Node A, and a Node B may then train a Model B using the reference model as Model A (e.g., assuming Node A will use the reference model as Model A for inference). Node A may then use the reference model as Model A without further training, or Node A may proceed to train the reference model to use as Model A. In some embodiments, multiple reference models may be established for Model A, and Node B may train one or more versions of Model B corresponding to one or more of the reference models for Model A. In embodiments with multiple reference models for Model A, Node B may train one or more versions of Model B based on the multiple reference models for Model A, and Node B may indicate to Node A which version of Model B it has selected for use, which version or versions of Model B provide(s) best performance, and/or the like. Based on the indication from Node B, Node A may proceed with the reference model corresponding to the Model B indicated by Node B, or Node A may select any other model to use as Model A.

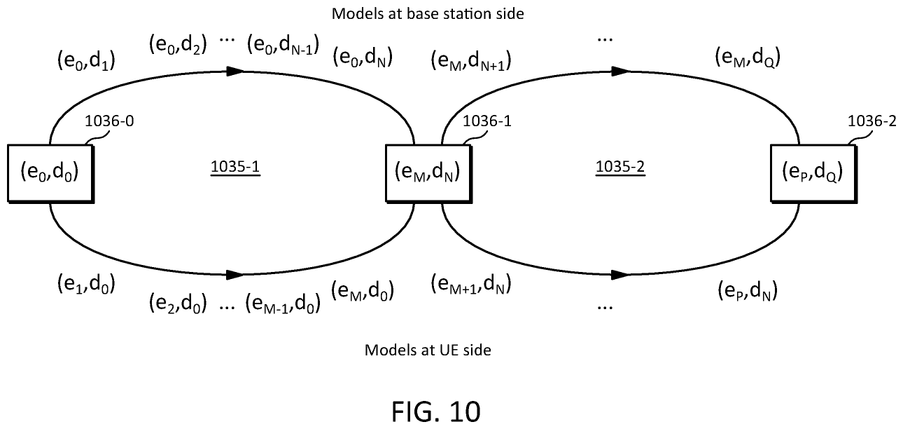

In a third type of framework, a Node A may begin with a Model A that may be in any initial state, for example, pre-trained (e.g., trained offline), untrained but configured with initial values, and/or the like. A Node B may begin with a Model B that may also be in any initial state. In some embodiments, before training their own models, Node A and/or Node B may have models that are matched to each other (e.g., trained together). One or both nodes may train their respective models for a period of time, then one or both nodes may share trained model values and/or trained models with the other node. An example embodiment is described in more detail below with respect to FIG. 10 where a first node (e.g., a UE) and a second node (e.g., a base station) may have a pair of models (e₀, d₀), where e₀ may be the encoder model in an initial state at the UE and d₀ may be the decoder model in an initial state at the base station. In a variation of the third type of framework, one or both nodes may train their respective models for one or more additional periods of time, and one or both nodes may share trained model values and/or trained models with the other node, for example, at the end of each period of time, at the end of alternating periods of time, and/or the like.

In any of the frameworks disclosed herein, when a model is transferred to or from a node, a corresponding quantizer or dequantizer may be transferred along with the mode.

In some embodiments, training data may be collected based on a resource window (e.g., a window of time and/or frequency resources). For example, a node may be configured to collect training data (e.g., channel estimates) for a specific range of frequencies (e.g., subcarriers, subbands, etc.) and a specific range of times (e.g., symbols, slots, etc.). The size of a window may be determined, for example, based on an amount of training data a node may be able to store in memory. The collected training data may be used for online training by one or more nodes or saved for offline training.

In some embodiments, pre-processing and/or post-processing may enable a pair of models to operate more effectively. For example, domain knowledge (e.g., frequency domain knowledge) of one or more inputs may be used to perform a pre-processing operation on at least a portion of one or more inputs to generate one or more transformed inputs. The one or more transformed inputs may be applied to a generation model to generate a representation of the one or more transformed inputs. The representation of the one or more transformed inputs may be applied to a reconstruction model that may generate a reconstructed transformed input (e.g., the one or more transformed inputs, or an approximation thereof). Domain knowledge may also be used to perform a post-processing operation (e.g., an inverse of the pre-processing operation) on the reconstructed transformed input to recover the original one or more inputs or an approximation thereof. Depending on the implementation details, transforming inputs and/or outputs (e.g., based on domain knowledge) may exploit one or more correlations between elements of the one or more inputs, thereby reducing the processing burden, memory usage, power consumption, and/or the like, of the generation model and/or the reconstruction model.

In some embodiments, a node may be provided with processing time for a model. For example, if a node is configured to perform online training of a model (e.g., using a training data set that is provided to the node or collected by the node), the node may be expected to update the model within a predetermined number of symbols or other measure of time.

Some embodiments in accordance with the disclosure may implement a scheme in which multiple pairs of models may be trained, deployed, and/or activated for use by one or more nodes (e.g., by a pair of nodes). For example, different pairs of trained models may be activated to handle different channel environments, different matrix dimensions (e.g., for channel matrices, precoding matrices, etc.), and/or the like. In some embodiments, a pair of models may be activated by signaling (e.g., RRC signaling, MAC-CE signaling, etc.). In some embodiments, a first node (e.g., a gNB) may also indicate to a second node (e.g., a UE) to switch or deactivate a current active model, for example, via RRC, MAC CE or dynamic signaling. A pair of models may be activated to train one or more of the models, use one or more of the models for inference, and/or the like.

Some embodiments in accordance with the disclosure may implement one or more formats for a representation of feedback information that may be generated by a generation model at a first node and transmitted to a second node for reconstruction. For example, a format for a representation of feedback information may be established as a type of uplink control information (UCI). A format may involve one or more types of coding (e.g., polar coding, low density parity check (LDPC) coding, and/or the like) which may depend, for example, on a type of physical channel used to transmit the UCI.

In some embodiments, CSI compression performance may be improved using AI and/or ML, for example, by exploiting one or more correlations in the time, frequency and/or space domains, and/or by defining a training data set across time, frequency, and/or space.

This disclosure encompasses numerous inventive principles relating to artificial intelligence and machine learning for a physical layer of a communication system. These principles may have independent utility and may be embodied individually, and not every embodiment may utilize every principle. Moreover, the principles may also be embodied in various combinations, some of which may amplify the benefits of the individual principles in a synergistic manner.

For purposes of illustration, some embodiments may be described in the context of some specific implementation details and/or applications such as compressing, decompressing, and/or sending channel feedback information between one or more UEs, base stations (e.g., gNBs), and/or the like, in 5G NR systems. However, the inventive principles are not limited to these details and/or applications and may be applied in any other context in which physical layer information may be processed and/or sent between wireless apparatus regardless of whether any of the apparatus may be base stations, UEs, peer devices, and/or the like, and regardless of whether a channel may be a UL channel, a DL channel, a peer channel, and/or the like. Moreover, the inventive principles may be applied to any type of wireless communication systems that may process and/or exchange physical layer information such as other types of cellular networks (e.g., 4G LTE, 6G, and/or any future generations of cellular networks), Bluetooth, Wi-Fi, and/or the like.

### Machine Learning Models for Physical Layer

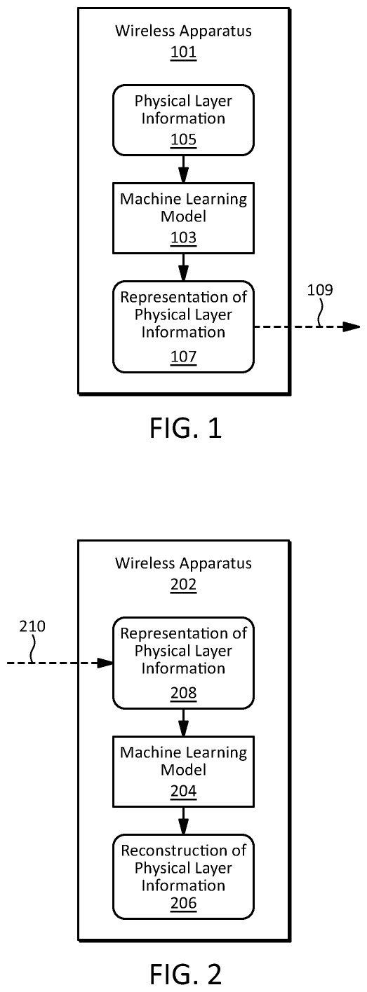

FIG. 1 illustrates an embodiment of a wireless communication apparatus according to the disclosure. The apparatus 101 may include a machine learning model 103 that may receive physical layer information 105 as an input and generate a representation 107 of the physical layer information as an output. In some implementations, the apparatus 101 may transmit the representation 107 of the physical layer information to one or more other apparatus as shown by arrow 109.

The representation 107 of the physical layer information may be a compressed, encoded, encrypted, mapped, or otherwise modified form of the physical layer information 105. Depending on the implementation details, the modification of the physical layer information 105 by the machine learning model 103 to generate the representation 107 of the physical layer information may reduce the resources involved in transmitting the physical layer information 105 between apparatus.

The machine learning model 103 may be implemented with one or more of any types of AI and/or ML models including neural network (e.g., deep neural network), linear regression, logistic regression, decision tree, linear discriminant analysis, naive Bayes, support vector machine, learning vector quantization, and/or the like. The machine learning model 103 may be implemented, for example, with a generation model.

The physical layer information 105 may include any information relating to the operation of a physical layer of a wireless communication apparatus. For example, the physical layer information 105 may include information (e.g., status information, precoding information, etc.) relating to one or more physical layer channels, signals, beams, and/or the like. Examples of physical layer channels may include one or more of a physical broadcast channel (PBCH), physical random access channel (PRACH), physical downlink control channel (PDCCH), physical downlink shared channel (PDSCH), physical uplink shared channel (PUSCH), physical uplink control channel (PUCCH), physical sidelink shared channel (PSSCH), physical sidelink control channel (PSCCH), physical sidelink feedback channel (PSFCH), and/or the like. Examples of physical layer signals may include one or more of a primary synchronization signal (PSS), secondary synchronization signal (SSS), channel state information reference signal (CSI-RS), tracking reference signal (TRS), sounding reference signal (SRS), and/or the like.

FIG. 2 illustrates another embodiment of a wireless communication apparatus according to the disclosure. The apparatus 202 may include a machine learning model 204 that may receive a representation 208 of physical layer information as an input and generate, as an output, a reconstruction 206 of physical layer information on which the representation 208 may be based. In some implementations, the apparatus 202 may receive the representation 208 of the physical layer information from one or more other apparatus as shown by arrow 210.

The reconstruction 206 (which may be referred to as a reconstructed input) may be the physical layer information on which the representation 208 may be based, or an approximation, estimate, prediction, etc., of the physical layer information on which the representation 208 may be based. The reconstruction 206 may be a decompressed, decoded, decrypted, reverse-mapped, or otherwise modified form of the physical layer information on which the representation 208 may be based.

The machine learning model 204 may be implemented with one or more of any types of AI and/or ML models including neural network (e.g., deep neural network), linear regression, logistic regression, decision tree, linear discriminant analysis, naive Bayes, support vector machine, learning vector quantization, and/or the like. The machine learning model 204 may be implemented, for example, with a reconstruction model.

The reconstructed physical layer information 206 may include any information relating to the operation of a physical layer of a wireless communication apparatus, for example, one or more channels, signals, and/or the like as described above with respect to the embodiment illustrated in FIG. 1.

Although not limited to any specific uses, the wireless communication apparatus 101 and 202 illustrated in FIG. 1 and FIG. 2, respectively, may be used together to facilitate the transmission of physical layer information from between the apparatus. For example, in some embodiments, apparatus 101 may be implemented as a UE in which the model 103 is implemented as a generation model, and apparatus 202 may be implemented as a base station in which the model 204 may be implemented as a reconstruction model. In such an embodiment, the generation model 103 may generate the representation 107 by compressing physical layer information 105 (e.g., relating to a DL channel from the base station to the UE).

The UE may transmit the representation 107 to the base station (e.g., using a UL channel). The base station may input the representation (indicated as 208) to the reconstruction model 204 which may generate reconstructed physical layer information 206. The base station may use the reconstructed physical layer information 206, for example, to facilitate DL transmissions from the base station to the UE. Depending on the implementation details, transmitting the physical layer information 105 in the form of a compressed representation 107 may reduce the amount of UL resources associated with transmitting the physical layer information 105.

### Two-Model Training

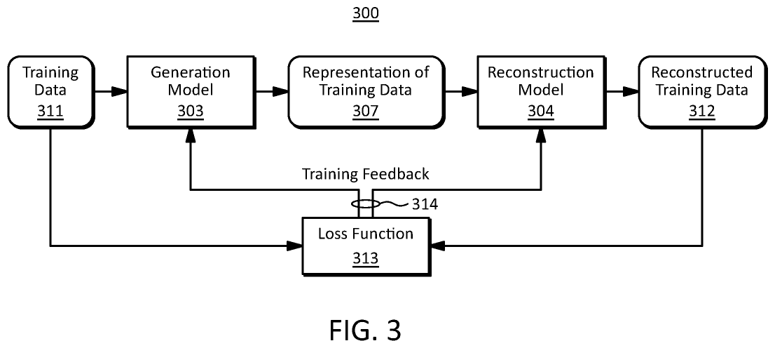

FIG. 3 illustrates an embodiment of a two-model training scheme according to the disclosure. The embodiment 300 illustrated in FIG. 3 may be used, for example, with one or more of the models illustrated in FIG. 1 and FIG. 2, or any other embodiments disclosed herein.

Referring to FIG. 3, training data 311 may be applied to a generation model 303 which may generate a representation 307 of the training data. A reconstruction model 304 may generate a reconstruction 312 of the training data based on the representation 307 of the training data. In some embodiments, the generation model 303 may include a quantizer to convert the representation 307 to a quantized form (e.g., a bit stream) that may be transmitted through a communication channel. Similarly, in some embodiments, the reconstruction model 304 may include a dequantizer that may convert a quantized representation 307 (e.g., a bit stream) to a form that may be used to generate the reconstructed training data 312.

The generation model 303 and reconstruction model 304 may be trained as a pair, for example, by using a loss function 313 to provide training feedback 314 to the generation model 303 and/or the reconstruction model 304. The training feedback 314 may be implemented, for example, using gradient descent, backpropagation, and/or the like. In embodiments in which one or both of the generation model 303 and reconstruction model 304 may be implemented with one or more neural networks, the training feedback 314 may update one or more values of weights, hyperparameters, and/or the like, in the generation model 303 and/or the reconstruction model 304.

In some embodiments, the loss function 313 (which may be implemented, for example, at least partially with a reconstruction loss) may operate to train the generation model 303 and reconstruction model 304 to generate the reconstructed training data 312 to be close to the original training data 311. This may be accomplished, for example, by reducing or minimizing a loss output of the loss function 313.

For example, if the training data 311 is represented as x, and the reconstructed training data 312 is represented as \hat{x}, the generation model 303 may be represented by a function ƒ(x), and the reconstruction model 304 may be represented by a function g(ƒ(x)), and thus, \hat{x}=g(ƒ(x)). The loss function 313 may be represented as L(x, \hat{x}). Thus, in some embodiments, training the pair of models 303 and 304 may involve reducing or minimizing L through the use of training feedback 314.

Although not limited to any specific type of representation 307 of the training data, in some embodiments, the pair of models 303 and 304 may seek to reduce the dimensionality of the representation 307 of the training data relative to the original training data 311. For example, the generation model 303 may be trained to generate a feature vector that may identify or separate one or more features (e.g., latent features) of the training data that may reduce the overhead associated with storing and/or transmitting the representation 307. The reconstruction model 304 may similarly be trained to reconstruct the original training data 311, or an approximation thereof, based on the representation 307.

Once trained, the generation model 303 and/or reconstruction model 304 may be used for inference, for example, in one or both of the wireless communication apparatus 101 and 202 illustrated in FIG. 1 and FIG. 2, respectively, or any other embodiments disclosed herein. Moreover, the two-model training scheme described with respect to FIG. 3 may be used with one or more frameworks for training models and/or transferring models between wireless apparatus as disclosed herein. The training described with respect to FIG. 3 may be performed anywhere, for example, at the wireless apparatus 101, at the wireless apparatus 202, at another location (e.g., at a server remote from both apparatus 101 and 202), or at a combination of any such locations. Moreover, once trained, one or both of the generation model 303 and/or reconstruction model 304 may be transferred to another location for use for inference. In some embodiments, once trained, one of the models may be discarded and the remaining model may be used, for example, as a pair with a separately trained model.

### Machine Learning Models for Channel Information Feedback

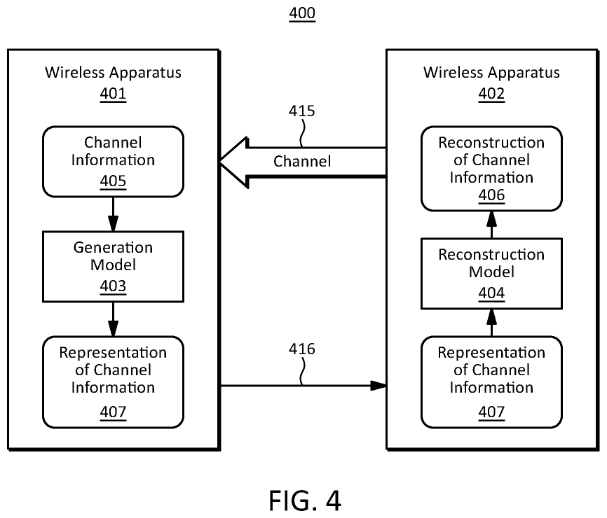

FIG. 4 illustrates an embodiment of a system having a pair of models to provide channel information feedback according to the disclosure. The system 400 illustrated in FIG. 4 may be used to implement, or may be implemented with, any of the apparatus, models, training schemes, and/or the like disclosed herein, including those illustrated in FIG. 1, FIG. 2, and FIG. 3.

Referring to FIG. 4, the system 400 may include a first wireless apparatus 401 and a second wireless apparatus 402. The first wireless apparatus 401 may be configured to receive transmissions from second wireless apparatus 402 through a channel 415. To improve the effectiveness (e.g., efficiency, reliability, bandwidth, etc.) of the transmissions through the channel 415, the first wireless apparatus 401 may provide feedback to the second wireless apparatus 402 in the form of channel information 405 that may be obtained, for example, by measuring one or more signals (e.g., reference signals) transmitted by the second wireless apparatus 402 through the channel 415.

The first wireless apparatus 401 may use a first machine learning model 403, which in this example may be implemented as a generation model, to generate a representation 407 of the channel information 405. The first wireless apparatus 401 may transmit the representation 407 to the second wireless apparatus 402, for example, using another channel, signal, and/or the like 416. The representation 407 may be a compressed, encoded, encrypted, mapped, or otherwise modified form of the channel information 405. Depending on the implementation details, the modification of the channel information 405 by the machine learning model 403 to generate the representation 407 may reduce the resources involved in transmitting the channel information 405 to the second wireless apparatus 402.

The second wireless apparatus 402 may apply the representation 407 of the channel information to a second machine learning model 404 which in this example may be implemented as a reconstruction model. The reconstruction model 404 may generate a reconstruction 406 of the channel information 405. The reconstruction 406 (which may be referred to as a reconstructed input) may be the channel information 405 on which the representation 407 may be based, or an approximation, estimate, prediction, etc., of the channel information 405. The reconstruction 406 may be a decompressed, decoded, decrypted, reverse-mapped, or otherwise modified form of the channel information 405. The second wireless apparatus 402 may use the channel information 405 to improve the manner in which it transmits to the first wireless apparatus 401 through the channel 415.

The system 400 illustrated in FIG. 4 is not limited to any specific apparatus (e.g., UEs, base stations, peer devices, etc.), applications (e.g., 4G, 5G, 6G, Wi-Fi, Bluetooth, etc.) and/or implementation details. However, for purposes of illustrating some of the inventive principles, some example embodiments may be described in the context of a 5G NR system in which a UE may receive different DL signals from a gNB.

### Uplink and Downlink Transmissions

In an NR system, a UE may receive DL transmissions that include a variety of information from a gNB. For example, a UE may receive user data from the gNB in a specific configuration of time and frequency resources referred to as a Physical Downlink Shared Channel (PDSCH). A Multiple Access (MAC) layer at the gNB may provide user data that is intended to be delivered to the corresponding MAC layer at the UE side. The Physical (PHY) layer of the UE may receive the physical signal received on the PDSCH and apply it as an input to a PDSCH processing chain, the output of which may be fed as an input to the MAC layer at the UE. Similarly, the UE may receive control data from the gNB using a Physical Downlink Control Channel (PDCCH). The control data may be referred to as Downlink Control Information (DCI) and may be converted to a PDCCH signal through a PDCCH processing chain on the gNB side.

A UE may send UL signals to the gNB to convey user data and control information using a Physical Uplink Shared Channel (PUSCH) and a Physical Uplink Control Channel (PUCCH), respectively. The PUSCH may be used by the UE MAC layer to deliver data to the gNB. The PUCCH may be used to convey control information, which may be referred to as Uplink Control Information (UCI), which may be converted to PUCCH signals through a PUCCH processing chain at the UE side.

### Channel State Information

In an NR system, a UE may include a Channel State Information (CSI) generator that may calculate a channel quality indicator (CQI), a precoding matrix indicator (PMI), a CSI reference signal resource indicator (CRI), and/or a rank indication (RI) any or all of which may be reported to one or more gNBs serving the UE. A CQI may be associated with a modulation and coding scheme (MCS) for adaptive modulation and coding and/or frequency selective resource allocation, a PMI may be used for a channel-dependent closed-loop multiple-input multiple-output system, and an RI may correspond to the number of useful transmission layers.

In an NR system, CSI generation may be performed based on a CSI reference signal (CSI-RS) transmitted by the gNB. A UE may use the CSI-RS to measure downlink channel conditions and generate CSI, for example, by performing a channel estimation and/or a noise variance estimation based on measurements of the CSI-RS signal.

In an NR system, CSI may be reported to a serving gNB using a Type-I codebook which may provide implicit CSI feedback to a gNB in the form of an index that may point to a predefined PMI. Alternatively, or additionally, CSI may be reported to a serving gNB using a Type-II codebook which may provide explicit CSI feedback in which a UE may determine one or more dominant eigenvectors or singular vectors based on DL channel conditions. The UE may then use the dominant eigenvectors or singular vectors to derive a PMI that may be fed back to the gNB which may use the PMI for beamforming in the DL channel.

The use of codebooks may provide adequate performance, for example, in embodiments with a limited number of antenna ports and/or users. However, in systems with larger numbers of antenna ports and/or users (e.g., multiple-input multiple-output (MIMO) systems), and particularly with the use of frequency division duplexing (FDD), the relatively low resolution of a Type-I codebook may not provide CSI feedback with adequate accuracy. Moreover, the use of a Type-II codebook may still involve the transmission of a significant amount of overhead data on a UL channel.

Depending on the implementation details, some embodiments of channel information feedback schemes based on machine learning according to the disclosure may enable a UE to send full CSI information to a gNB while reducing the overhead associated with the UL transmission to the gNB. Moreover, the inventive principles are not limited to a UE sending CSI to a gNB but may be applied to any situation in which a first apparatus may send channel information feedback to a second apparatus (e.g., reporting channel conditions for uplink channels from a UE to a gNB, reporting channel conditions for sidelink channels between UEs, and/or the like).

### Example Embodiments

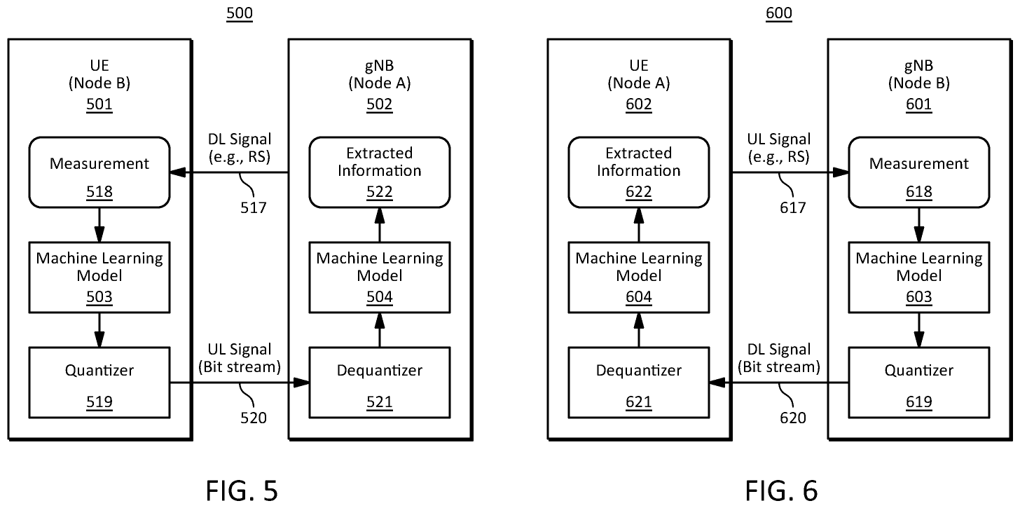

FIG. 5 illustrates an example embodiment of a system for reporting downlink physical layer information according to the disclosure. The system 500 may include a UE 501 (which may be designated as Node B) and a gNB 502 (which may be designated as Node A). The gNB 502 may send a transmission of a DL signal 517 (e.g., a reference signal (RS) transmission) to the UE 501 which may extract a measurement 518 from the transmission. The UE 501 may include a model 503 that may be configured, for example, as an encoder to encode the measurement 518 into a feature vector relating to the DL physical layer. The encoded measurement may then be quantized by a quantizer 519 and transmitted back to the gNB 502 as a UL signal 520 (e.g., a bitstream). In some embodiments, the description of a model at a node may also include a quantizer and/or dequantizer description, for example, a function that may map channel information (e.g., a real CSI codeword) at the output of an encoder model to quantized values or a bit stream, and vice versa at a decoder model at the other node. The gNB 502 may apply the received UL signal 520 to a dequantizer 521 to generate an equivalent feature vector which may be fed to a model 504 to extract information 522 (e.g., necessary or optional information) relating to the DL physical layer.

FIG. 6 illustrates an example embodiment of a system for reporting uplink physical layer information according to the disclosure. In some aspects, the system 600 illustrated in FIG. 6 may be similar to the system 500 illustrated in FIG. 5, but the system 600 may be configured to report uplink physical layer information instead of downlink physical layer information.

Specifically, the system 600 may include a gNB 601 (which may be designated as Node B) and a UE 602 (which may be designated as Node A). The UE 602 may send a transmission of a UL signal 617 (e.g., a reference signal (RS) transmission) to the gNB 601 which may extract a measurement 618 from the transmission. The gNB 601 may include a model 603 that may be configured, for example, as an encoder to encode the measurement 618 into a feature vector relating to the UL physical layer. The encoded measurement may then be quantized by a quantizer 619 and transmitted back to the UE 602 as a DL signal 620 (e.g., a bitstream). The UE 602 may apply the received DL signal 620 to a dequantizer 621 to generate an equivalent feature vector which may be fed to a model 604 to extract information 622 (e.g., necessary or optional information) relating to the UL physical layer.

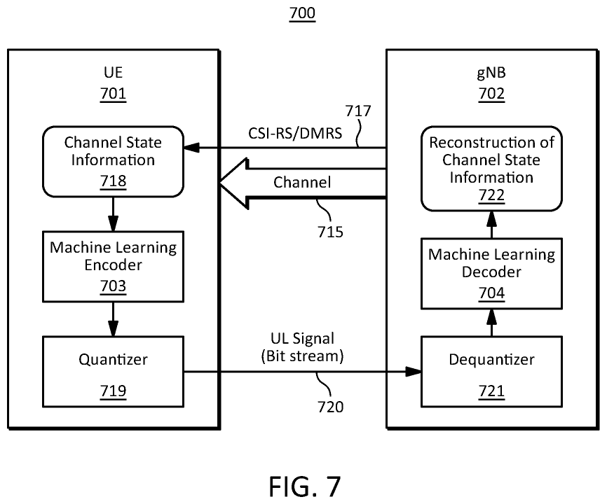

FIG. 7 illustrates an example embodiment of a system for reporting downlink physical layer channel state information according to the disclosure. Depending on the implementation details, the system 700 illustrated in FIG. 7 may enable a gNB or other base station to retrieve full CSI information from a UE (in contrast, for example, to a codebook based pointer, precoding matrix indicator, and/or the like) while using ML models to compress the CSI (e.g., into a relatively low number of bits), thereby reducing the uplink resource overhead involved in sending the CSI.

The system 700 may include a UE 701 and a gNB 702. The gNB 702 may transmit a DL reference signal 717 such as a CSI-RS or demodulation reference signal (DMRS) that may enable the UE 701 to determine CSI 718 for a DL channel 715. The UE 701 may include an ML model 703 that may be configured as an encoder to encode the CSI 718 into a feature vector.

The UE 701 may also include a quantizer 719 that may quantize the feature vector into a stream of bits that may be transmitted to the gNB 702 using a UL signal 720. The gNB 702 may include a dequantizer 721 that may reconstruct the feature vector from the stream of bits. The feature vector may then be fed into an ML model 704 that may be configured as a decoder to reconstruct an estimate 722 of the CSI 718.

In some embodiments, a performance metric ƒ(H, Ĥ) may be used to evaluate the accuracy of the design, configuration, and/or training of the encoder model 703, decoder model 704, quantizer 719, and/or dequantizer 721. For example, the performance metric ƒ(H, Ĥ) may be implemented as a measure of the error between channel estimates as follows:

$$f ( H , \hat{H} ) = \frac{{‖ H - \hat{H} ‖}^{2}}{{‖ H ‖}^{2}} \qquad ( 1 )$$

where H and Ĥ may represent the channel estimates (e.g., CSI) at the UE 701 and gNB 702, respectively. Such performance metrics may be useful, for example, to evaluate the accuracy of channel state information extracted by the gNB 702.

Additionally, or alternatively, the system 700 may be configured to enable the UE 701 to use the DL reference signal 717 to determine a precoding matrix based on the current channel conditions. The precoding matrix may then be encoded into a feature by encoder model 703, quantized by quantizer 719, and transmitted to the gNB 702 using the UL signal 720. At the gNB 702, the dequantizer 721 may recover the feature vector which may be applied to the decoder model 704 to reconstruct an estimate of the precoding matrix. For example, for a channel realization H, a suitable precoding matrix may be implemented as a set of singular vectors S using Singular Value Decomposition (SVD) of H which may be given as H=SΣD where Σ may be a diagonal matrix and D may be a unitary matrix. In such an embodiment, the encoder model 703, decoder model 704, quantizer 719, and/or dequantizer 721 may be configured to enable the gNB 702 to extract a set of singular vectors (e.g., a matrix) S, and a performance metric may be implemented accordingly. Although the embodiment illustrated in FIG. 7 reports downlink physical layer information, other embodiments may be configured to report uplink physical layer information, sidelink physical information, and/or the like using similar principles according to the disclosure.

### Model Development, Training, and Operation

Artificial intelligence (AI), machine learning (ML), deep learning, and/or the like (any or all of which, as mentioned above, may be referred to individually and/or collectively as machine learning or ML) may provide techniques for inferring one or more functions (e.g., complex functions) of data according to the disclosure. In a machine learning process, samples of data may be provided to an ML model which, in turn, may apply one of various machine learning techniques to learn how to determine the one or more functions using the provided data samples. For example, a machine learning process may allow an ML model to learn a function ƒ(x) of a data sample input x. As mentioned above, an ML model may also be referred to as a model.

In some embodiments, a machine learning process (which may also be referred to as a development process) may proceed in one or more stages (which may also be referred to as phases) such as training, validation, testing, and/or inference (which may also be referred to as an application stage). Some embodiments may omit one or more of these stages and/or include one or more additional stages. In some embodiments, all or a portion of one or more stages may be combined into one stage, and a stage may be split into multiple stages. Moreover, the order of the stages or portions thereof may be changed.

In a training stage, a model may be trained to perform one or more target tasks. A training stage may involve the use of a training data set that may include i) data samples, and ii) an outcome of the function ƒ(x) for the samples (e.g., each sample) in the training data set. In a training stage, one or more training techniques may enable a model to learn an approximate relation (e.g., an approximate function) that may behave as, or closely follow, the function ƒ(x).

In a validation stage, the model may be tested (e.g., after performing an initial training) to assess the suitability of the trained model for one or more target tasks. A model may undergo further training if the validation result is not satisfactory. The training stage may be considered to be successfully completed if a validation stage provides successful results.

In a testing stage, a trained model may be tested to assess the suitability of the trained ML model for the one or more target tasks. In some embodiments, a trained model may not proceed to a testing stage unless training is completed and validation provides successful results.

In an inference stage, the trained model is used (e.g., in real-world application) to perform the one or more target tasks.

In a testing and/or inference stage, a model may use a learned approximate function that has been obtained via a training phase to determine the function value ƒ(x) of other data samples which can be different than the samples in the training phase.

In some embodiments, the success and/or performance of a machine learning process may involve the use of a sufficiently large training data set that may contain sufficient information about the function ƒ(x) and thus enables the model to obtain an acceptably close approximation of the function ƒ(x) through the training stage.

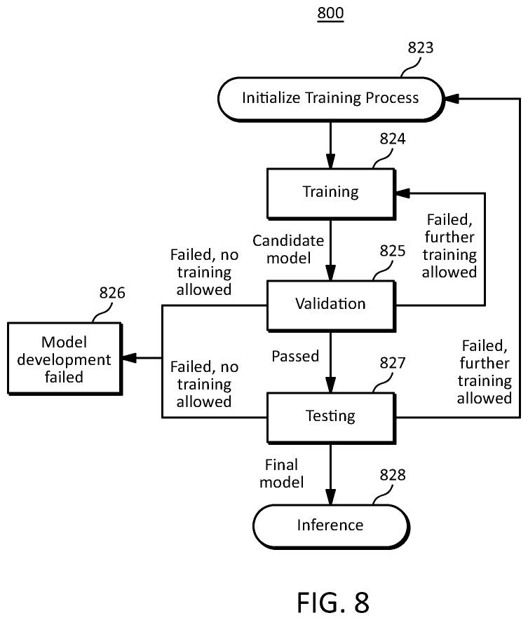

FIG. 8 illustrates an embodiment of a learning process for a machine learning model according to the disclosure. The process 800 may begin at operation 823 at which a training process may be initialized. For example, the structure of the model may be determined, values (e.g., neural network weights, hyperparameters, etc.) of the model may be initialized, a training data set with an adequate number of samples may be constructed, and/or the like.

At operation 824, the initialized model may be trained using the training data set to determine a configuration of a candidate trained model, for example, by updating values of neural network weights, hyperparameters, etc., using gradient descent, backpropagation, and/or the like.

In some embodiments, there may be an interrelationship between the construction of a training data set and the training stage. For example, the training stage may involve a relatively large duration of time for completion, and the duration can be dependent on the number of samples in the training dataset. The duration may depend, in turn, on a type of training. For example, for full training and/or initial training, the model may be initialized and training may be performed using a large dataset that may consist of many samples (e.g., samples that may not have been used previously for training the model). As another example, for partial training and/or update training, the model may be been previously trained (or partially trained), and an event (e.g., obtaining new data samples, performance degradation of the model, a model update event, etc.) may prompt a modification or adaptation of the model. In the case of partial training and/or update training, the model may be trained using a modified data set that may be different from the large training data set used for full training and/or initial training. For example, the modified training data set may be a subset of the full dataset used for initial training, a set of new data samples that have been newly acquired, or a combination thereof.

At operation 825, the trained candidate model may be validated. In some embodiments, the validation stage 825 may be performed iteratively with the training stage 824. For example, if the candidate model fails the validation stage 825, it may return to the training stage 824 which may generate a new candidate model. In some embodiments, different criterion may be established for determining validation success or failure (e.g., classification accuracy, minimum mean square error (MMSE), and/or the like).

In some embodiments, a failed candidate model may not be allowed to return to the training stage 824 (for example, after failing a number of times that exceeds a threshold or if a performance criteria does not pass a threshold over a particular duration or a particular number of validation steps), and the method may terminate at to operation 826. However, if the performance of the candidate model using validation data is determined to be acceptable (e.g., based on the criteria for determining success or failure), the validation may be considered successful, and the trained candidate model may be passed to a testing stage at operation 827.

At operation 827, the performance of a trained model candidate that has passed the validation stage may be assessed. Criteria for declaring successful testing and/or failure of a model during the testing stage of development may be similar to the criteria used in the validation stage. However, one or more parameters used with the criteria during the testing stage (e.g., a number of steps, a performance threshold, etc.) may or may not be different from those used in the validation stage.

If testing is successful, the model may be designated as a final model, and the process may proceed to operation 828. In some embodiments, if the model fails the testing stage, the process may return to the training stage at operation 824 for further training. In some embodiments, however, further training may not be allowed (for example, based on criteria similar to those used during the validation stage 825), and the process may terminate at operation 826.

### Model Training and Deployment Frameworks

Some embodiments in accordance with the disclosure may implement one or more frameworks for training and/or deploying models. In some embodiments of frameworks disclosed herein, one or more models trained and/or developed by a node may be tested against one or more reference models for the node, for example, to assess the compliance of the model with one or more potential test cases that may be specified for a respective application.

In any of the embodiments of frameworks disclosed herein, a quantizer function may be differentiable with a derivative value of essentially zero (e.g., with a probability of 1) throughout some or all of a quantizer range (e.g., essentially throughout the entire range). Depending on the implementation details, this may result in backpropagation that may provide little or no updating encoder weights. Thus, in some embodiments, a quantizer function may be approximated with a differentiable function (e.g., a reference differentiable quantizer function) that may be referred to as ƒ_{quantizer,approx}(x) in a training phase, while the actual quantizer function may be used in an inference phase. Similarly, a dequantizer function may be approximated with a differentiable function (e.g., a reference differentiable dequantizer function) that may be referred to as ƒ_{dequantizer,approx}(x) in a training phase, while the actual dequantizer function may be used in an inference phase. In some embodiments, a quantizer or dequantizer function used in conjunction with a model may be considered part of a complete description of the corresponding model and may be transferred along with, and as part of, the model. Thus, with any of the frameworks disclosed herein, if a first node shares a trained model with a second node (e.g., if Node A trains a pair of models Model A and Model B, then sends the trained Model B to Node B), the first model may also share one or both of the approximated quantizer function ƒ_{quantizer,approx}(x) and/or approximated dequantizer function ƒ_{dequantizer,approx}(x) with the second node, for example, via RRC signalling.

Although the frameworks disclosed herein are not limited to any specific applications and/or implementation details, in some embodiments, and depending on the implementation details, the frameworks may be used to train and/or test models that may reduce CSI feedback overhead.

### Joint Training Frameworks

In some embodiments, a pair of models (e.g., Model A and Model B) may be jointly trained by one of two nodes (Node A or Node B), and the trained model for the non-training node may be conveyed to the non-training node (e.g., if joint training is performed by Node A, the trained Model B may be conveyed to Node B) to use for inference. For example, in the context of CSI compression, a base station may perform joint training of a pair of encoder and decoder models, and then convey the encoder model to the UE. An encoder model may also be referred to as an encoder, and a decoder model may also be referred to as a decoder.

In some embodiments of a joint training framework, further training (e.g., fine tuning) of one or both of the trained models may be performed by the nodes at which the models may be used for inference (e.g., to improve or optimize one or both of the models). In some embodiments, further training may be based on online data that may be obtained by one or more of the nodes, for example, during on-going communication.

In some embodiments of a joint training framework, the training node may train one or both models using a corresponding quantizer and/or dequantizer function (e.g., an approximated and/or differentiable quantizer and/or dequantizer function). A node that receives a trained model may also receive and use the corresponding quantizer and/or dequantizer function for further training, validation, testing, inference, and/or the like.

In some implementations, joint training of models by a node may result in models that may be jointly matched to a target task, and thus, may provide improved or optimized performance. Depending on the implementation details, such performance improvement may outweigh any communication overhead associated with conveying a model to a different node, and/or any mismatch between models and/or nodes that be caused, for example, by joint training at one node that may be produced by a different manufacturer than the other node.

In a variation of a joint training framework, one node, for example, a base station, may jointly train a pair of encoder and decoder models. The encoder and decoder pair may be trained, for example, using reference differentiable quantizer and dequantizer functions as described above. The base station may then share the trained decoder model with the UE, e.g., via RRC signaling. However, the base station may or may not share the trained encoder model with the UE. If the base station shares the trained encoder model with the UE, the UE may use the trained encoder model as a reference encoder model. If the base station does not share the trained encoder model with the UE, the UE may establish a reference encoder model based, for example, on randomly initialized weights, on weights that may be chosen for the UE implementation, or on any other basis.

The UE may then train the reference encoder model using the trained decoder model it received from the base station. The reference encoder model may be trained online (which may refer to training that may be performed during operation). In some implementations, online training may be performed on the fly (which may refer to training performed using training data (e.g., channel estimates H) that may be collected during operation). Thus, the UE may train the reference encoder model using channel estimates H that may be collected over time. The collected channel estimates may be used as a new training data set, for example, at certain points during training. Moreover, the collected channel estimates H may also be stored for future online and/or offline training by the UE or any other apparatus.

The UE may then use the trained encoder model for inference. The UE may also share the trained encoder model with the base station. This training procedure may continue as more training samples, e.g., channel estimates H, are collected and used by the UE for training.

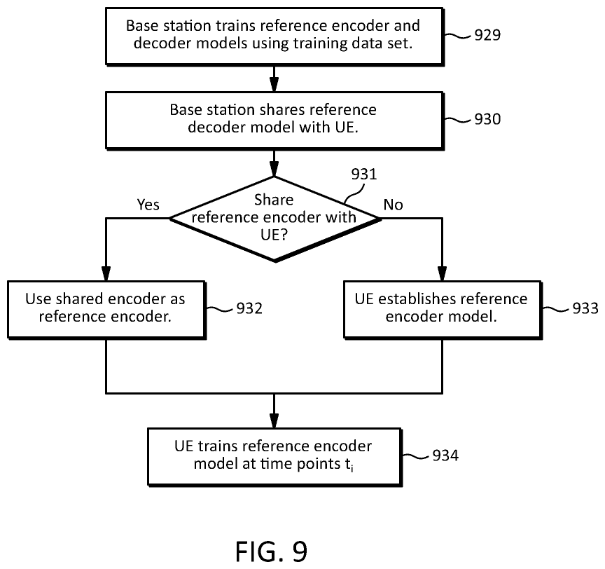

FIG. 9 illustrates an example embodiment of a method for joint training of a pair of encoder and decoder models according to the disclosure. At operation 929, a base station may jointly train a pair of reference encoder and decoder models using a training data set which may be referred to as Enc_{ref} and Dec_{ref}. At operation 930, the base station may share the reference decoder model Dec_{ref} with a UE. At operation 931, the base station decides whether to share the reference encoder model with the UE. If the base station shares the reference encoder with the UE, then at operation 932, the UE may use the shared reference encoder as the reference encoder for training. If the base station does not share the reference encoder with the UE, then at operation 933, the UE may establish a reference encoder model, for example, using random weights, using weights based on the UE implementation, and/or the like. At operation 934, the UE may train the reference encoder model at time points tᵢ. [UE trains reference encoder model at time points tᵢ.] The time points tᵢ may be determined, for example, as times at which the UE has performed and collected sufficient channel estimates since a previous time point. This may be implemented, for example, as shown in Algorithm 1 where, for each time point tᵢ, the UE may have collected a new online training set Sᵢ on the fly, where Sᵢ may include channel estimates from tᵢ₋₁ to tᵢ, and N may be a maximum number of online trainings at the UE side. In some implementations, after completing Algorithm 1, the UE may share the trained encoder model with the base station.

Algorithm 1

| | |
|---|---|
| 1 | For i=1, ... N |
| 2 | UE trains encoder model with training set Sᵢ using reference |
| | encoder model as initial weights |
| 3 | UE sets the reference encoder model to the trained encoder model |
| 4 | UE constructs new training data set containing channel estimates |
| | from time tᵢ₋₁ to tᵢ |

Any of the training and deployment frameworks disclosed herein may be used with any types and/or combinations of apparatus and with any type of model and/or physical layer information. For example, even though, in the embodiment illustrated in FIG. 8, the base station performs the initial joint training and the encoder and decoder may be trained and used with channel estimates, in other embodiments the joint training may be performed by a UE or any other apparatus and the models may be trained and used with precoding matrices or any other type of physical layer information.

In some embodiments, a node such as a UE or base station may collect new training data within a window (e.g., an explicit time and/or frequency window). The collected data may be used, for example, to construct a training data set that the node may use to train a model. A window may be configured with a start and/or end time that may be determined, for example, by a base station. In some embodiments, a timeline used to determine a data collection window may be measured, for example, from one or more CSI-RS resources.

Alternatively, or additionally, online training may be performed as follows. A first node base station) may have a first model, and second node may have second model that may form a pair with the first model. In some embodiments, the first and second nodes may operate in a connected mode (e.g., an RRC connected mode). One or both of the nodes may have obtained their model through sharing by the other node. In this example, one of the nodes may be a base station and the other node may be a UE.

The base station may configure a UE with a predetermined online training data set, and both nodes may use the predetermined online training data set to update their respective models. When a node updates its own model, the other model at the other node may be assumed to be frozen. In some embodiments, one or more online training data sets may be specified (e.g., as part of a specification and/or provided to the UE and/or base station by a third node). Once the first node updates its first model (e.g., an encoder or decoder), it may share the updated first model with the second node, and the second node may begin training its second model assuming the first model is frozen. The models may continue to alternate between periodically training and freezing their models, for example, until an end time is reached.

Although the embodiments disclosed above may be described in a context in which a UE may update and use an encoder, in some embodiments with online training, both a UE and a base station (or any two other nodes with a pair of models such as two UEs configured for sideband communications) may collect new training data and use it to update either their own model (e.g., an encoder or a decoder), or both models (e.g., both an encoder and decoder which may be configured, for example, as an auto-encoder).

In some embodiments, a first node may share newly collected training data (e.g., channel matrices) with a second node by transmitting the training data as data or control information. For example, a UE may generate a binary representation of one or more channel matrices and transmit the representation using a PUSCH or PUCCH following the normal procedures for uplink transmission, i.e. encoding, modulation, etc.

Alternatively, or additionally, a UE may use its encoder as currently trained to encode a channel matrix it has obtained. The UE may transmit the encoded channel matrix, which may be referred to as a CSI codeword, to a base station. The base station may then use its currently trained decoder to recover the channel matrix. The base station may then include the recovered channel matrix in a new training data set that may be used for further (e.g., online) training at the base station.

In some embodiments, in addition to exchanging training data between nodes, one or more nodes may also share their latest trained models (e.g., encoders and/or decoders) with another node. Sharing of training data and/or models may be performed at intervals (e.g., a model may be transmitted when it is updated) that may manage the amount of communication overhead involved in such sharing.

In a framework with online training of models, a node may use a memory buffer to store collected physical layer information (e.g., CSI matrices from time from tᵢ₋₁ to time tᵢ). Depending on the implementation details, a node may collect some or all of a new training data set before may begin using the new training data to update a model. However, if a node uses a dedicated memory buffer to store a training data set, and the interval between time tᵢ₋₁ and time tᵢ exceeds a certain value, the amount of memory involved with storing the training data may exceed the available buffer size as the number of CSI-RSs in the time window may become too large. Also, even if the interval between time tᵢ₋₁ and time tᵢ is generally short enough to prevent a buffer overflow, a node may encounter some reference signals with relatively short periodicities (e.g., a relatively large number of reference signals (e.g., CSI-RSs) may be configured in the window), and thus, the CSI matrices collected based on the reference signals may exceed the available dedicated memory buffer.

In some embodiments, a node may declare a data buffering capability that may be related, for example, to the size of a training data set constructed from collected training data. Depending on the implementation details, this may reduce or prevent problems with exceeding the capacity of a memory buffer for new training data. For example, a node may declare or be assigned a predetermined memory buffer capability based on (1) a time gap (e.g., a maximum time gap) for obtaining training data and/or updating a model based on the obtained training data; (2) a maximum number of reference signals (e.g., CSI-RSs) within a time window the node is expected to use for constructing a training set; or (3) the shorted periodicity of reference signals (e.g., CSI-RSs) used for constructing the training data set. A situation in which a node may be configured with one or more reference signals and/or a time window that may violate the predetermined memory buffer capability may be considered an error case.

Alternatively, or additionally, a default behavior may be defined when a violation of the predetermined memory buffer capability of a node occurs. For example, if a configuration of reference signals and/or a time window violates a node's memory buffer capacity, the node may use only store and/or use a subset of the collected training data to update a model. For example, if the UE reports a maximum of N_max CSI-RSs within a window, and a gNB configures a larger number N_(CSI-RS) of CSI-RSs within the window, the UE may only use N_max CSI-RSs from the N_(CSI-RS) CSI-RSs to update the model. How the UE selects which CSI-RSs to use may be determined based on the UE implementation and/or according to one or more configured and/or fixed rules (e.g. the UE may use the latest N_max resources among the N_(CSI-RS) resources).

In some embodiments, a buffer size for collected training data may be based on a node implementation, for example, without involving a specification. For example, if a UE's training data buffer overflows, the UE may stop storing newly collected data (e.g., matrices) and proceed to update the model with the data in the buffer. In some embodiments, the UE may flush the buffer once the model is updated, then begin collecting new training data again.

In some embodiments, UE may use a shared buffer to store new training data. Examples of shared buffers may include one or more buffers already used for storing other channels, e.g., a PDSCH buffer, a master CCE LLR buffer, and/or the like. In such an embodiment, the shared buffer space may be used based on availability as it may already be fully or partially occupied based on other dedicated uses. In some embodiments, buffering of collected training data may be based on the node implementation.

### Training Frameworks with Reference Models

In some frameworks according to the disclosure, a reference model may be established as Model A for Node A, and Node B may then train a Model B using the reference model as Model A (e.g., assuming Node A will use the reference model as Model A for inference). Node A may then use the reference model as Model A without further training, or Node A may proceed to train the reference model to use as Model A. In some embodiments, one or multiple Model As may be provided and/or specified for a Node A, and a Node B may train one or more Model Bs using a Model A at Node B that may be assumed to be one or multiple of the reference models for Node A. For example, Node B may train a first version of Model B using a Model A that is assumed to be one reference model specified for Model A. Node B may also train a second version of Model B assuming Model A to be another reference model and so on.

References models may be established, for example, through specifications, signalling (e.g., RRC signalling from a base station to a UE after a UE is RRC-connected), and/or the like.

In some embodiments, Node B may inform Node A of which reference models it has selected to use to train the different versions of Model A. In cases in which there is only one reference model available for Model A, no communication may be involved because the reference model can be known implicitly. Node B may inform Node A of one reference model among the multiple reference models available for training versions of Model B; this model may correspond, for example, to the reference model that provided the best performance. Alternatively, or additionally, Node B may inform Node A of a subset of the reference models among the multiple reference models; this subset may include a collection of the best-performing reference models.

Regardless of any signalling from Node B to Node A, Node A may or may not indicate to Node B which reference model it has selected. Indicating the reference model can be useful, for example, to establish a common understanding between Node A and Node B, whereas not indicating the reference model may reduce signalling overhead. In an implementation with multiple reference models, if the subset of best performing models includes only one reference model, (e.g., only one reference model was indicated from Node B to Node A as the best performing reference model), then Node A may not provide an indication to Node B because the selection by Node A may be implicitly known by Node B.

Once a reference model is established for Node A, Node A may either use the reference model as Model A or proceed to train the reference model. Depending on the implementation details, using the reference model as Model A (e.g., with little or no further training or tuning) may provide a relatively high level of matching (e.g., the best matching) between the two models because Node B may train Model B assuming the use of the reference model for Model A. If there are multiple reference models used by Node B to train different versions of Model B, then Node A may use a reference model corresponding to any of the trained versions of Model B; this may involve establishing a establish a common understanding between Node A and Node B of which of the trained versions of Model B will be used (e.g., Node B may communicate to Node A which trained version of Model B is used, or Node A may inform Node B of which model to use).

Rather than using the reference model as Model A without further training, Node A may proceed to train Model A. This may be beneficial, for example, if the reference model is not suitable for the current network status (e.g., the wireless environment if the models are to be used for CSI compression and decompression). Thus, allowing Node A to further train (e.g., tune or optimize) Model A may enable the models to match the current network status. However, changing Model A from the reference model that was assumed by Node B when training Model B may lead to a potential mismatch between the two models which, in turn, may lead to a degradation of performance.

In some embodiments, Model A may be trained to overcome this potential mismatch. For example, to train Model A, Node B may send Model B to Node A so the training of Model A may be based on the actual model used by Node B as Model B.

If there are multiple trained versions of Model B, Node B may communicate a subset of the trained versions of Model B, and Node A may train multiple corresponding Model As for the communicated versions of Model B. In such an embodiment, Model A and Model B may communicate to establish a common understanding of which pair of Model A and Model B may be selected for use. Depending on the implementation details, sharing multiple versions of Model A may allow Node A and/or Node B to improve (e.g., optimize) performance by selecting the best pair of Model A and Model B, among the communicated models, which may be best-performing. Alternatively, to reduce communication overhead, Node B may communicate one of the multiple versions of Model B, and Node A may train a Model A corresponding to the communicated version of Model B.

Alternatively, or additionally, if Node A proceeds to train Model A, Node A may train a trial version of Model B to mimic the actual Model B used by Node B. The level of similarity between the trial Model B and the actual Model B may depend on the design and/or architecture of Model B, the training data set used to train the trial version of Model B, and/or the training procedure (e.g., initializations of weights, hyperparameters, etc.) use to train the trial version of Model B. If there are multiple trained versions of Model B that have been trained by Node B, Node A may train multiple corresponding trial versions of Model B. Alternatively, Node A may train multiple Model As using a trial version of Model B corresponding to each of the available reference models for Model A; this may be particularly useful because it may enable Node A to train Model A prior to being informed by Node B of which reference model or models Node B has selected. In such an embodiment, Model A and Model B may communicate to establish a common understanding of which pair of Model A and Model B may be selected for use.

To further reduce the mismatch between a trial Model B and an actual Model B, Node B may share some auxiliary information with Node A. Depending on the implementation details, sharing auxiliary information may help Node A train a trial Model B in a manner that would produce a trial Model B similar to the actual Model B. Examples of auxiliary information may include initialization values (e.g., random seeds used by Node B for training an actual Model B, initial network weights, etc.), one or more optimization algorithms, one or more algorithms used for feature selection, one or more algorithms used for data preprocessing, information on the type of neural network (e.g., a recurrent neural network (RNN), a convolutional neural network (CNN), etc.), information about the structure of the model (e.g., a number of layers, a number of nodes per layer, etc.), information about the training data set, and/or the like. Using this information can be mandated (e.g., via a specification) or left to the implementation of a node.

In some embodiments, a reference model for Node A and/or Node B may be specified (e.g., in a specification), for example, for testing purposes. Such an embodiment may not involve any indication of which model is used by Node A and/or Node B. For example, a UE may be expected to meet one or more performance specifications when the gNB uses one or more reference models. Depending on the implementation details, this may provide a guideline for deployment as to which models to be used by nodes to attain suitable performance for a machine learning task. In some embodiments, one or more performance requirements may be established for a machine learning CSI compression task, for example, as part of a specification.

In some embodiments of a framework with a reference model, a node may train any model, including a reference model, using a corresponding quantizer and/or dequantizer function (e.g., an approximated and/or differentiable quantizer and/or dequantizer function), and any model may also use a corresponding quantizer and/or dequantizer function for further training, validation, testing, inference, and/or the like.

### Training Frameworks with Latest Shared Values

In some frameworks according to the disclosure, Node A may begin with a Model A that may be in any initial state (e.g., pre-trained (e.g., trained offline), untrained but configured with initial values, and/or the like). Node B may begin with a Model B that may also be in any initial state. One or both nodes may train their respective models for a period of time (which may be referred to as a training cycle or iteration), then one or both nodes may or may not share trained model values and/or trained models with the other node. In some embodiments, a new training data set may be provided directly or indirectly to one or both nodes, e.g., at the beginning or end of a cycle. Node A and Node B may train their respective models with their latest knowledge of the weights of the model at the other node, e.g., without any model exchange.

A first node may train its model (e.g., a UE may train an encoder) assuming the model at the second node (e.g., a decoder at a base station) is frozen with the latest weights (e.g., that were fed back by the second node). The first node may train its model and updates its weights, for example, a maximum number of times (e.g., Kₑ times for an encoder) and then share the updated model weights with the second node. The same procedure may be implemented at the second node. Specifically, once the second node has received the updated model weights from the first node, the second node may train its model and update its weights a maximum number of times (e.g., K_{d} times for a decoder), assuming the model weights of the model at the first node are frozen at the latest states shared model by the first node. The second node may then share its updated model weights with the first node. Thus, the first and/or second nodes may have trained their respective models a maximum number of times and then shared updated model values with the other node (which may be referred to as a sharing cycle or iteration).

In a variation of this framework, after one or more of the nodes shares model state information (e.g., weights) with the other node, e.g., at the end of a sharing cycle, one or both of the nodes may begin another sharing cycle. For example, both nodes may train their models assuming the values of the model on the other node is frozen to the latest values shared by the other node. At certain points in time, or after a certain number of training cycles are performed by the first and/or second nodes (e.g., at the end of another sharing cycle), one or both nodes may stop training and share their latest trained model with each other node. In some embodiments, at the beginning, a shared model (e.g., a fully shared model that may be initialized, for example, through offline training, hand shaking, etc.) may be used for the initial values of the latest shared weights.

FIG. 10 illustrates an example embodiment of a method for training models with latest shared values according to the disclosure. For purposes of illustration, the method illustrated in FIG. 10 may be described in the context of a UE having an encoding model for CSI and a base station having a decoding model for CSI, but the principles may be applied to any types of nodes and/or physical layer information.

Referring to FIG. 10, at the beginning of a first sharing cycle 1035-1, an encoder model may be in an initial state e₀, and a decoder model may be in an initial state d₀ as shown at sharing point 1036-0. The encode and decoder models in the initial states (e₀, d₀) may both be provided to a UE and base station. Thus, the UE and base station both begin with encoder and decoder models in the same initial state. The UE may then perform M training cycles (e.g., trains its encoder M times while its decoder model remains in the initial state d₀). While the UE is performing M training cycles, the base station may perform N training cycles (e.g., trains its encoder N times while its encoder model remains in the initial state e₀).

For example, after a first training cycle by the UE, the UE's encoder and decoder models may have states (e₁, d₀), after a second training cycle by the UE, the UE's encoder and decoder models may have states (e₂, d₀) and so on until, after the Mth training cycle, the UE's encoder and decoder models may have states (e_{M}, d₀).

Similarly, after a first training cycle by the base station, the base station's encoder and decoder models may have states (e₀, d₁), after a second training cycle by the base station, the base station's encoder and decoder models may have states (e₀, d₂) and so on until, after the Nth training cycle, the base station's encoder and decoder models may have states (e₀, d_{N}).

At sharing point 1036-1 at the end of sharing cycle 1035-1, the UE may send its trained encoder model to the base station, and the base station may send its trained decoder model to the UE. Thus, both the UE and base station may have encoder and decoder models with states (e_{M}, d_{N}).

In some embodiments, UE and/or base station may stop training at this point and begin using their trained encoder and decoder models for inference. In some other embodiments, however, one or both of the UE and/or base station may begin another sharing cycle 1035-2. For example, the UE may then perform P training cycles by training its encoder P times while its decoder model remains in the state d_{N}, and the base station may perform Q training cycles by training its decoder Q times while its encoder model remains in the state e_{M}.

At sharing point 1036-2 at the end of sharing cycle 1035-2, the UE may send its trained encoder model to the base station, and the base station may send its trained decoder model to the UE. Thus, both the UE and base station may have encoder and decoder models with states (e_{P}, d_{Q}). The UE and/or base station may perform any number of sharing cycles, and any number of training cycles per sharing cycle.

A special case of the embodiment illustrated in FIG. 10 is when M or N=0., if M>>N, or if N>>M. For example, with N=0, and M>0, the base station may not update the decoder model (e.g., may not perform any training cycles) during the sharing cycles. The UE, however, may train its encoder M times before sharing it with the base station. Similarly, with M=0, and N>0, the UE may not update its encoder model while the base station may update its decoder model N times before sharing it with the UE. Depending on the implementation details, one or more of these special cases may be beneficial, for example, if one of the nodes has difficulty or is unable to obtain a training data set for online training at the node. In such a situation, the node with access (or more ready access) to training data may continue with online training which may enable the node that continues with training to provide a trained model to the other node that has no or limited access to training data.

A special case may also be performed in an interlaced and/or alternating manner. For example, the two nodes may start with one of the variables M or N equal to zero while the other variable is greater than zero. Once the model with the applicable model is updated a number of times determined by the nonzero variable and shared with the other node, the non-zero variable may take a zero value while the other variable becomes non-zero. This process may continue with M and N alternatingly take zero values. Such an interlaced training procedure may cause a first node (e.g., a UE or gNB) to train its model (e.g., an encoder or decoder) a number of times while the model at a second node is frozen. Then, after the first node shares its trained model with the second node, the second node may train its model a number of times while the model of the first node is frozen and so on.

In some embodiments, the value of the nonzero variable may affect the performance of the trained pair of models. For example, if the time between sharing points is relatively large, the trained models (e_{M}, d_{N}) may have relatively poor performance, for example, if each node has been training assuming a model weight on the other side that may be significantly different from the model that will be shared at the next sharing point. For example, in the embodiment illustrated in FIG. 10, the base station may train its decoder assuming an encoder with weights e₀ and may later pair the trained decoder with a new encoder model e_{M} which may have diverged significantly from e₀. Thus, in some embodiments, sharing models with relatively high frequency may improve the performance of the trained models.

In any of the frameworks disclosed herein, a node may train any model, including a reference model, using a corresponding quantizer and/or dequantizer function (e.g., an approximated and/or differentiable quantizer and/or dequantizer function), and any model may also use a corresponding quantizer and/or dequantizer function for further training, validation, testing, inference, and/or the like.

With any of the frameworks disclosed herein, one or more of the nodes may transfer collected training data and/or data sets (e.g., channel estimates, precoding matrices, etc.) to another apparatus that may train one or more of the models. For example, a UE and/or base station may upload collected online training data and/or one or more models to a server (e.g., a cloud based sever) that may train one or more of the models using the uploaded training data and download one or more trained models to the UE and/or base station.

Any of the frameworks disclosed herein may be modified such that a first type of node may train a model for another type of node and share the trained model with multiples instances of the second type of node. For example, a base station may train an encoder for its decoder and shares the trained encoder with multiple UEs. One or more of the UEs may apply the shared encoder to compress CSI at the UE and/or use the shared encoder for further online training. Moreover, any of the frameworks disclosed herein may be implemented in systems in which one of the nodes is not a base station, for example, with two UEs or other peer devices configured for sidelink communications. In such an implementation, a UE may train a decoder for its encoder and share the trained decoder with one or more other UEs that may use the trained decoder for direct inference and/or as a source of initial values (e.g., of weights) for further online training.

### Model Sharing Mechanisms

In some embodiments, nodes may transfer models, weights, and/or the like, using any type of communication mechanism such as one or more uplink and/or downlink channels, signals, and/or the like. For example, upon triggering sharing of an encoder model, a UE may use one or more MAC control element (MAC CE) PUSCHs to send the encoder model and/or weights to a gNB. Similarly, a gNB may send a decoder model and/or weights in one or multiple UEs using one or more MAC CE PDSCHs.

Depending on the implementation details, sharing a full set of weights may be inefficient as the model may be relatively large and may consume relatively large amounts of downlink and/or uplink resources for sharing.

Some embodiments may establish one or more sets of quantized models that may be referred to as model books. Upon training a model by a node, if sharing is requested, the node may map the model to one of the quantized models in a model book. One or more of the model books may be commonly shared between nodes. Rather than sending a mode, the node may send an index of the mapped model in a model book. Depending on the implementation details, this may reduce communication resources associated with model sharing.

In some embodiments, once a set of parameters for a model are known, the end result of training may be deterministically known. For example, given (1) a training set, (2) an initial random seed that determines the initial weights, (3) an optimizer parameter (e.g., a fully defined optimizer parameter), and/or a training procedure, the trained model at the end of a certain number of training epochs (e.g., training cycles) may be uniquely determined. These parameters may be referred to, for example, as minimal describing parameters. If the size of the minimal describing is smaller than the size of the weights for a model, then a node may share the minimal describing parameters rather than the weights. Depending on the implementation details, this may reduce communication overhead associated with sharing models.

In some embodiments, one or more values of a model (e.g., weights of a CSI encoding and/or deciding model at a node) may be arranged in a vector W (e.g., a vector of weight elements). A dedicated compression auto-encoder model (e.g., an encoder and decoder model pair) may be trained to compress W with an encoder at one node and a decoder at the other node. If sharing of the CSI model is triggered and/or requested, a node may construct the vector W of the CSI model, and encode it with the model-compression encoder and send the encoded vector to the other node. The other node may use the model-compression decoder to recover the weight vector W. Depending on the implementation details, this may reduce communication overhead associated with sharing models.

### Online Training Processing Time

In embodiments in which a node may perform online training of a model, the node may be provided with a resource allowance (e.g., an allowance of processing time, processing resources, and/or the like) to perform the training. Such an allowance may be provided for training with an online training data set that may be collected by the node (e.g., channel estimations based on measurements performed by the node), or online training data sets that may be RRC configured (or re-configured) or MAC-CE activated. A resource processing time allowance may ensure that a node may have sufficient time to update a model using the online training data set before the node is expected to have completed the update, for example, to share an updated model with another node. In some embodiments, however, a node may be provided with a processing time allowance regardless of whether the node is expected to share a trained model after the processing.

For example, in embodiments in which a UE may collect an online training data set by calculating channel estimations, the UE may be provided an amount of time (e.g., to update an encoder model) determined by N_{AIML,update} symbols from the end of the last symbol of the latest CSI-RS used for the online training set. If the UE is configured to report the updated model to another node (e.g., a gNB), the UE may not be expected to report the model to the gNB earlier than N_{AIML,report} symbols from the last symbol of the latest CSI-RS in the training set.

As another example, in embodiments in which a UE may perform online training of an encoder using an online training data set that is RRC configured (or re-configured) or MAC-CE activated to the UE, the UE may not be expected to update and/or report its encoder earlier than N symbols from the latest symbol at which the corresponding RRC (re)-configuration is complete or the MAC-CE activation command has been received.

### Pre-Processing Based on Domain Knowledge

For purposes of compression, a machine learning encoder may receive an input signal and generate a set of output features that may be sufficient for a decoder to use to reconstruct the input signal. With maximal compression, the output features may be expected to be independent of each other, otherwise they may be further compressed.

Although a pair of machine learning models may be capable of generating a feature vector from an input and reconstructing the input from the feature vector, in some embodiments according to the disclosure, one or more pre-processing and/or post-processing operations may be performed on the input to a generation model and/or the output from a reconstruction model. Depending on the implementation details, this may provide one or more potential benefits such as reducing the processing burden and/or memory usage of one or both of the models, improving the accuracy and/or efficiency of one or both of the models, and/or the like.

In some embodiments, pre-processing and/or post-processing may be based on domain knowledge of the input signals. In some embodiments, pre-processing and/or post-processing may provide an encoder with auxiliary information from the domain knowledge which, depending on the implementation details, may reduce the processing burden on the encoder. For example, if a vector that is to be compressed by an encoder may be characterized as a low-pass signal with a relatively small variation, a discrete Fourier transform (DFT) and/or inverse DFT (IDFT) may be performed to analyze the frequency domain representation of the vector. If a DC component of the DFT vector is larger (e.g., significantly larger) than the other components, it may indicate that the signal has a low variation and, therefore, may be pre-processed before compression by the encoder (and post-processed after decompression by the decoder) to reduce the burden on the encoder/decoder pair.

In some embodiments, performing a transform and-or inverse transform such as a DFT and/or an IDFT may provide a machine learning model with a clearer understanding of the level of correlation between the elements of an input vector. For example, in some embodiments (e.g., with any of the frameworks disclosed herein), a CSI matrix may be input to a pre-processor that may apply a transform (e.g., DFT/IDFT, discrete cosine transform (DCT)/inverse DCT (IDCT), and/or the like) to all or a portion of the input, e.g. on different CSI-RS ports. The transformed signal may then be input to the encoder and compressed. On the decoder side, the output of the decoder may be applied to an inverse operator of the pre-processor transformation (which may be implemented, for example, with a post-processor) to generate a reconstructed input signal.

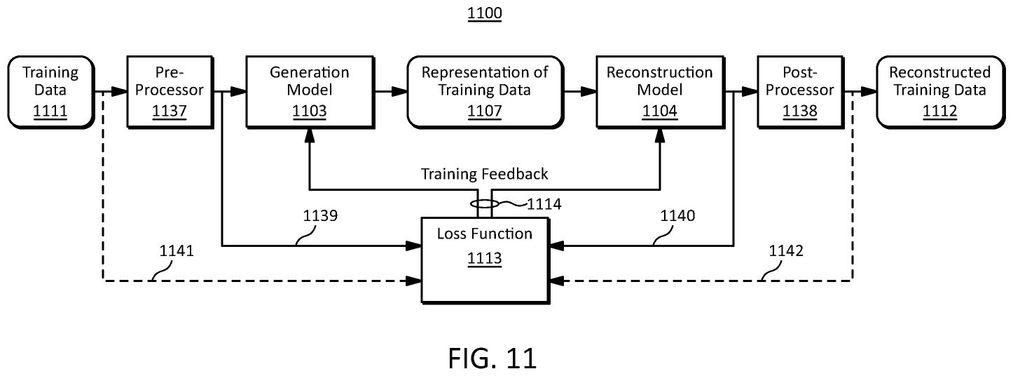

FIG. 11 illustrates an example embodiment of a two-model training scheme with pre-processing and post-processing according to the disclosure. In some aspects, the embodiment 1100 illustrated in FIG. 11 may be similar to the embodiment illustrated in FIG. 3, and similar components may be identified with reference designators ending in the same digits. However, the embodiment illustrated in FIG. 11 may include a pre-processor 1137 and a post-processor 1138. The pre-processor 1137 may apply any type of transformation to the training data 1111 before it is applied to the generation model 1103. Similarly, the post-processor 1138 may apply any type of inverse transformation (e.g., an inverse of a transformation applied by the pre-processor 1137) to the output of the reconstruction model 1104 to generate the final reconstructed training data 1112.

In some embodiments, the loss function 1113 for training the models 1103 and 1104 may be defined between the input of the generation model 1103 and the output of the reconstruction model 1104 as shown by the solid lines 1139 and 1140. In some embodiments, however, the loss function 1113 may be defined between the input of the pre-processor 1137 and the output of the post-processor 1138 as shown by the dashed lines 1141 and 1142. Once the models 1103 and 1104 are trained as shown in FIG. 11, they may be used for inference.

Although the principles relating to pre-processing and/or post-processing are not limited to any specific implementation details, for purposes of illustrating the inventive principles, an example embodiment of a scheme for pre- and post-processing CSI matrices based on domain knowledge may be implemented as follows. With a channel matrix of size Nᵣₓ×Nₜₓ, for each pair (i, j) of RX and TX antenna, the channel elements corresponding to the pair for all of the resource elements (REs) within a time and frequency window may be concatenated to obtain a combined matrix H_{i,j} of size M×N where M and N may be the number of subcarriers and orthogonal frequency division multiplexing (OFDM) symbols of the CSI-RSs in the window. In some embodiments, the matrix may be assumed to be complex. In an example embodiment of a pre-processing scheme, H_{i,j} may be transformed, for example, using DFT matrices. If U_{fref} and Uₜᵢₘₑ are the M×M and N×N DFT matrices, respectively, the matrix H_{i,j} may be transformed to X_{i,j} as follows

X_{i,j}=U*_{freq}H_{i,j}Uₜᵢₘₑ (2)

which may be referred to as the delay-Doppler representation (DDR) of H_{i,j}. Matrix H_{i,j} may be reconstructed from the DDR as follows:

H_{i,j}=U_{freq}X_{i,j}U*ₜᵢₘₑ, (3)

In some embodiments, the use of a DDR transform may result in a sparse X matrix which, in turn, may ease the learning and inference complexity.

In some embodiments, the use of pre-processing and/or post-processing transforms may enable the original training set to transform the corresponding DDR matrices. In such an embodiment, the CSI compression may then compress the transformed training set. Thus, pre-processing (e.g., a DDR transform) may be performed on the UE side while post-processing (e.g., an inverse of DDR to recover H) may be performed at the gNB side.

In some embodiments, a loss function may be defined based on the transformed matrices (e.g., between the transformed matrix input to the encoder and the transformed matrix output of the decoder as illustrated in FIG. 11).

In some embodiments, the matrix H may be constructed based on the union of the individual CSI matrices in time and/or frequency domains for each spatial channel, for example, for each transmission antenna (port) and each receive antenna (port) pair. One or multiple models may be trained and tested for each spatial channel. In some embodiments, H may be constructed based on the channel matrices of the REs, e.g., where each matrix may have a size of Nᵣ×Nₜ in which Nᵣ and Nₜ may be the number of receive antennas at a UE and transmit antennas at a gNB, respectively.

### CSI Matrix Formulations

In some embodiments, the CSI information of an RE or a group of REs that a UE may compress may be referred to as a CSI matrix. From an analysis of multiple-input, multiple-output (MIMO) channel, a capacity distribution may be a Gaussian distribution with possibly different power allocation across a transmit antenna. If a channel matrix is decomposed as H_{r×t}=UΣV^{H}, the capacity achieving distribution may be obtained by first setting \tilde{x}=Vx where x is the i.i.d. Gaussian random vector with zero mean and unit variance and then multiplying each element of

$$\tilde{x} = [ \begin{matrix}{\tilde{x}}_{1} \\ ⋮ \\ {\tilde{x}}_{t}\end{matrix} ] \qquad ( 4 )$$

by the power allocation given by a water filling algorithm. The power allocation to the i-th channel may be Pᵢ, i=1, . . . , t where the Pᵢ may be obtained from the singular value decomposition of the channel matrix H. Therefore, the information used at gNB (e.g., the full information required at the gNB) may be both the right singular value matrix V and the singular values themselves. Thus, in some embodiments, a CSI matrix may be formulated (e.g., defined) as any one or more of the following: (a) a CSI matrix may be formulated as the channel matrix H; (b) a CSI matrix may be formulated as the concatenation of V and the singular values; and/or (c) a CSI matrix may be formulated as the matrix U.

In some embodiments, a UE may be configured to report any of the CSI matrices described above via RRC (re)-configuration, MAC-CE command or dynamically via DCI. In an embodiment in which a CSI matrix is formulated according to (b) (e.g., the concatenation of V and the singular values) a UE may also be configured to only report the singular values.

For purposes of model training, when a UE is configured to report a specific CSI matrix the training set and/or loss function may be formulated based on the applicable CSI matrix. For example, when a UE is configured to report V, the training set may include the V matrices obtained from the estimated channel matrices, and the loss may be formulated based on a V matrix input to the encoder and the reconstructed V matrix at the output of the decoder.

### Node Capabilities

Implementation of any of the frameworks disclosed herein may involve the use of resources such as memory, processing, and/or communication resources, for example, to store new training data, share models between nodes, and train and/or apply a specific type of neural network architecture, e.g., CNN or RNN for a model. Different nodes such as UEs may have different capabilities for implementing the neural networks. For example, a UE may or may be capable of supporting a CNN but not an RNN. In some embodiments, a UE may report its capability for supporting a specific type of neural network architecture, e.g. a network type such as CNN, RNN, etc., and/or any other aspects reflecting its restrictions and capability for applying an encoder model.

In some embodiments, a node (e.g., a UE) may report its capabilities and/or restrictions using a list that may include any number of the following: (a) one or more network types, e.g., CNN, RNN, specific types of RNN, gated recurrent units (GRUs), long short-term memory (LSTM), transformer, and/or the like; (b) one or more aspects related to the size of a model, e.g., a number of layers, a number of input and/or output channels of a CNN, a number of hidden states of an RNN, and/or the like; and/or (c) any other type of structural restriction.

Depending on its reported capabilities, a node (e.g., a UE) may not be expected to train or test an encoder model that violates any of the node's reported constraints and/or requires capabilities beyond the node's declared capabilities. In some embodiments, this may be ensured regardless of the applicable framework and/or location of training/inference of the model. For example, if a framework is implemented such that a gNB may pre-train an encoder and decoder and shares the encoder and/or decoder with the UE, the UE may not expect the encoder model to violate its capabilities. As another example, if one or multiple pairs of encoders and decoders are trained offline and specified in an applicable specification (e.g., an NR specification), a UE may not expect the applicable model to violate its capabilities. In some embodiments, a UE may report a capability to activate one or more models through signaling and may declare which specific encoder/decoder pairs, or individual encoders or decoders it may support. A gNB may then indicate to the UE which encoder/decoder pair may be applicable to the UE. The indication may be provided, for example, by system information, RRC configuration, dynamic signaling in the DCI, etc.

### Tuning Via Online Training

In some frameworks a node such as a UE may be expected to train its encoder model or both an encoder model and a decoder model online, for example, by collecting new training data (e.g., samples) on the fly or based on offline provisioning and updating of one or more model. If a node only updates an encoder model, since a loss function may also depend on decoder weights, encoder model tuning and/or optimization may also depend on the decoder weights and/or model. In such an implementation a node may also declare capabilities to handle the restriction of the decoder model, even though the encoder may be used on the gNB side. One or more such restrictions may be applied as follows: (1) one or more online training features and/or fine tuning may be declared by a node as a capability; (2) a node that reports a capability to support online training may further report restrictions on the supported structures for the encoder model which may be, for example, any restrictions as mentioned above as (a) through (c); (3) a node that reports a capability to support online training may further report restrictions on the supported structures for the decoder model which may be, for example, any restrictions as mentioned above as (a) through (c); and/or (4) if multiple models including encoder and decoding pairs are specified in a specification, a node may declare a capability indicating which pairs of encoder and decoder, or which individual encoders and/or decoder the node may support.

### Multiple Pairs of Models

In some embodiments, multiple pairs of models (e.g., encoder/decoder pairs) may be trained and/or deployed for operation (e.g., simultaneous operation) on two nodes (e.g., a UE and a gNB). Pairs may differ from each other in a) both encoder and decoder, b) only encoder, or c) only decoder. In some embodiments, multiple pairs of models can be configured (e.g., optimized) to handle different cases that may be specified to handle different channel environments which may in turn result in different distributions of the training and/or testing data sets.

Multiple pairs of models may be used, for example, to accommodate different dimensionality in training data. For instance, the dimensions of a CSI matrix may be determined according to the number of CSI-RS ports. In some embodiments, if a UE is to report a first CSI matrix H₁ and a second matrix H₂ with different dimensions, a single encoder and decoder pair may be used to handle matrices with different sizes. In such an embodiment the encoder and decoder may be trained as follows. The matrices input to the encoder may be reshaped to have a fixed size by appending zeros in a configuration that may be commonly understood between a UE and a gNB. Thus, a training set may originally include matrices of different sizes which may be modified by appending zeros as described above to convert the matrices to one fixed matrix size. A communication mechanism may be implemented to enable a gNB and a UE to share the same understanding on the size of the CSI matrix that is requested, for example in a report by a UE. Depending on the implementation details, a matrix re-dimensioning technique may work for any matrix size.

Alternatively, or additionally, multiple pairs of models (e.g., encoder/decoder pairs) may be trained, wherein different pairs of models may be configured to handle different CSI matrix sizes.

In some embodiments, and depending on the implementation details, multiple pairs of models may be implemented without increasing complexity. For example, with multiple pairs of models, if CSI reports include CSI matrices corresponding to a specific number of CSI-RS ports, then the inference time for calculating the CSI report may be smaller with multiple pairs than with a single pair. Moreover, if each RRC configuration or MAC-CE activation includes CSI reporting for a certain case corresponding to a certain pair, then UE may load the applicable model into a modem while keeping one or more of the other models in a UE controller.

Depending on the implementation details, this may reduce modem internal memory usage. In embodiments with multiple pairs, different pairs may be categorized according to any of the following configurations. (a) Each pair of models may be configured to handle a specific CSI matrix size. For example, a pair of models may receive CSI matrices estimated based on CSI-RS with a certain number of ports and also associated with a certain number of receive antennas by a UE. The UE may report its number of receive antennas to the gNB in one report, or separately for different numbers of CSI-RS ports. (b) Each pair of models may be configured to handle a different distribution for training and/or test data sets. (c) Each pair of models may be configured to handle a different channel environment for training and/or test data sets.

### Training Set Association and Model Pair Configuration

In embodiments in which pairs of models may be configured to handle different cases, a node (e.g., a UE or base station) may be configured with different training data sets, for example, different training data sets for a specific case or pair of models (e.g., encoder/decoder pair). Thus, a UE and/or base station may be in possession of different training data sets, e.g., each data set for a different pair. Once triggering takes place for a node (e.g., a UE or a gNB), the node may also be signalled as to which pair of models should be trained. For example, with online training, a gNB may indicate to a UE to start training of specific pair models. If online training is performed on the fly by collecting new data set, an association may be provided, for example, between a CSI-RS and an encoder/decoder pair, e.g., via the number of CSI-RS ports.

Once multiple pairs of models have been trained and are ready for deployment in an inference phase, a node (e.g., a UE) may need to know which pair to use to encode a channel matrix. For example, each pair may be associated with a certain dimension for a CSI matrix to encode. The dimension may be referred to as the input dimension to the encoder model. In some embodiments, a UE may determine the pair of models to use for encoding a CSI matrix as follows. A CSI-RS may be implicitly or explicitly associated with a pair of models. The UE encodes a CSI matrix using the pair of models associated with the CSI-RS. With an implicit association, the CSI-RS may be mapped to a certain pair based on the number of CSI-RS ports and/or the number of receive antennas at the UE. Thus, the CSI-RS may be mapped to a pair if the dimension of the CSI matrix obtained from the CSI RS is equal to the input dimension of the pair. If multiple pairs have the same eligible input dimensions, a reference pair may be chosen, for example, based on a rule that may be established between a UE and a gNB. With an explicit association, the CSI-RS for which the CSI matrix is reported may be configured via RRC or dynamically indicated in DCI, for example, with a pair index.

In any of the implementations described above, if UE is signaled to report a CSI matrix via a pair of models that have a different input dimension, the UE may append zeros to match the size of the matrix to the input dimension. However, a UE may not expect to be signaled to report a CSI matrix using a pair of models with an input dimension that is smaller than that of the CSI matrix.

### Compression with Reduced Model Size

In some embodiments, a pair of models may be configured as an auto-encoder to compress a CSI matrix, and/or exploit a redundancy and/or correlation between CSI matrix elements. If the CSI matrix is reported per RE, then the correlation may only be a spatial correlation between different paths between different pairs of transmit antennas (e.g., CSI-RS ports) and receive antenna. Depending on the implementation details, the amount of such correlation may be limited and thus an auto-encoder may not be able to compress the CSI matrix sufficiently.

In some embodiments, the compression capability of an auto-encoder may be related to the amount of redundancy and/or correlation between the elements of the CSI matrix, which may be referred to as spatial correlation. Since a wireless channel may also be correlated in time and/or frequency domains, time and/or frequency correlations may also exist. Therefore, an estimated channel for a number of OFDM symbols and/or a number of resource elements (REs), resource blocks (RBs) or sub-bands may be input as a single training sample. For example, channel matrices corresponding to multiple REs may be specified as an input to an auto-encoder. In one such method according to the disclosure, a UE may be configured via RRC with such a configuration that may specify time and/or frequency resource bundling for forming a training data set.

Depending on the implementation details, the compression performance of an auto-encoder may be improved by compressing CSI for multiple REs across different frequency and/or time resources. Thus, combined CSI matrices of multiple REs may be input in a time and frequency window. The combined CSI matrix may then be obtained by concatenating the individual CSI matrices of the REs in the window. Depending on the implementation details, a combined CSI matrix may be more likely to have significant correlation between its elements due to time and frequency flatness of the channel. Therefore if a model takes the combined CSI matrix as the input, it may be able to compress it to a higher degree than multiple models working on individual per-RE matrices. In some embodiments, a UE may be configured with a time and/or frequency window and one or more configurations that may indicate which REs a UE may employ to determine the combined CSI matrix. Such a configuration may be used in both training and/or testing phases to obtain the combined matrix.

### Input Size Reduction Via Subsets of CSI Matrix

In some embodiments, an auto-encoder may encode CSI matrices of different REs in certain time and frequency windows. If the channel is such that correlation between the elements of the channel matrices do not exist or are not strong in certain domains (e.g., time or frequency), then the set of elements in the union of the CSI matrices may be divided into subsets with relatively strong intra-subset element correlation and relatively weaker inter-subset element correlation. For example, if an auto-encoder is to compress four CSI matrices of four REs on the same OFDM symbol, the matrices may be denoted as follows:

$${H}_{1} = [ \begin{matrix}{a}_{1} & {a}_{2} \\ {a}_{3} & {a}_{4}\end{matrix} ] , {H}_{2} = [ \begin{matrix}{b}_{1} & {b}_{2} \\ {b}_{3} & {b}_{4}\end{matrix} ] , {H}_{3} = [ \begin{matrix}{c}_{1} & {c}_{2} \\ {c}_{3} & {c}_{4}\end{matrix} ] , {H}_{4} = [ \begin{matrix}{d}_{1} & {d}_{2} \\ {d}_{3} & {d}_{4}\end{matrix} ] . \qquad ( 5 )$$

If the correlation in the frequency domain is strong, and there is little or no correlation in the spatial domain (i.e. among the elements of one matrix), then an auto-encoder may be configured to compress a vector of length 4, and the auto-encoder may be applied four times on the following subsets: Subset 1 (a₁, b₁, c₁, d₁); Subset 2 (a₂, b₂, c₂, d₂); Subset 3 (a₃, b₃, c₃, d₃); and Subset 4 (a₄, b₄, c₄, d₄).

The CSI matrix may then be reconstructed at the decoder by reconstructing the four vectors, for example, using the same decoder. As mentioned above, the subsets may be chosen such that they may exploit one or more correlations in one or more domains. To further illustrate, in the example above, if there is a correlation between elements in a spatial domain, then the subset choices set forth above may prevent the network from exploiting the correlation to further compress the CSI matrix. In contrast, the following subset selections may allows for exploiting correlations in both the frequency and spatial domains: Subset 1 (a₁, a₂, b₁, b₂); Subset 2 (c₁, c₂, d₁, d₂); Subset 3 (a₃, a₄, b₃, b₄); and Subset 4 (c₃, c₄, d₃, d₄).

In some embodiments, the following framework may be used for reduced model size with N_{features} input dimensions based on this approach. (1) A UE may be configured to report CSI matrices of M REs which may be on the same or different OFDM symbols and may be within a time and/or frequency window. Each CSI matrix may have N elements. (2) A UE may divide the M×N elements into

$$\frac{M \times N}{{N}_{features}}$$

subsets. A common rule may be established between UE and gNB for the subset selection. (3) An auto-encoder (e.g., a single auto-encoder) may be used to compress and recover the N_{feature} elements in each subset. In the example subsets described above, M=N=4, and N_{features}=4.

### Input Size Reduction Via Resource Element Selection

The size of an encoder network may be reduced by reducing the size of a combined input matrix. In some embodiments, the size of a combined matrix may be reduced by (a) removing certain elements of individual per-RE matrices, for example, if there are two REs in a window with CSI matrices H₁ and H₂ of the same dimension. The combined matrix can be constructed to have the same dimension as H₁ or H₂, but by selectively picking the (i,j) elements from either H₁ or H₂. Alternatively, or additionally, the size of a combined matrix may be reduced by (b) constructing a matrix that may exclude the CSI matrices for certain REs in the window.

These examples are illustrated in Table 1 in which a window with two REs and two CSI matrices is illustrated. With approach (a) the combined matrix may be constructed as shown in Table 1, while with approach (b) the combined matrix may be constructed by choosing one of the two matrices.

TABLE 1

| | |
|---|---|
| ${H}_{1} = [ \begin{matrix}{a}_{1 , 1} & {a}_{1 , 2} & {a}_{1 , 3} & {a}_{1 , 4} \\ {a}_{2 , 1} & {a}_{2 , 2} & {a}_{2 , 3} & {a}_{2 , 4} \\ {a}_{3 , 1} & {a}_{3 , 2} & {a}_{3 , 3} & {a}_{3 , 4} \\ {a}_{4 , 1} & {a}_{4 , 2} & {a}_{4 , 3} & {a}_{4 , 4}\end{matrix} ]$ | ${H}_{combined} = [ \begin{matrix}{a}_{1 , 1} & {b}_{1 , 2} & {b}_{1 , 3} & {b}_{1 , 4} \\ {a}_{2 , 1} & {b}_{2 , 2} & {b}_{2 , 3} & {b}_{2 , 4} \\ {a}_{3 , 1} & {b}_{3 , 2} & {b}_{3 , 3} & {b}_{3 , 4} \\ {a}_{4 , 1} & {b}_{4 , 2} & {b}_{4 , 3} & {b}_{4 , 4}\end{matrix} ]$ |
| ${H}_{2} = [ \begin{matrix}{b}_{1 , 1} & {b}_{1 , 2} & {b}_{1 , 3} & {b}_{1 , 4} \\ {b}_{2 , 1} & {b}_{2 , 2} & {b}_{2 , 3} & {b}_{2 , 4} \\ {b}_{3 , 1} & {b}_{3 , 2} & {b}_{3 , 3} & {b}_{3 , 4} \\ {b}_{4 , 1} & {b}_{4 , 2} & {b}_{4 , 3} & {b}_{4 , 4}\end{matrix} ]$ | |

### Number of CSI-RS Ports and Training Set

A channel matrix estimated from a CSI-RS with Nₚₒᵣₜ ports and reception via Nᵣ receive antennas at a UE, may have a dimension of Nᵣ×Mₚₒᵣₜ. An auto-encoder may be used to remove redundancy from the matrices. In some embodiments, identifying the redundancy pattern and/or removing it may be more difficult if the training set includes matrices of different dimensions, e.g., corresponding to CSI-RS with different numbers of ports. Therefore in some embodiments, a training set for any of the methods disclosed herein may only or mostly include matrices of the same dimensions, and/or associated with the same number of CSI-RS ports. Thus, a UE may not be expected to be configured with a training set, or CSI report and measurement config that results in a training set with dimensions that are different from dimensions of the training data set matrices.

### UCI Format

With any of the frameworks disclosed herein, an output of a generation model (e.g., an ML encoder) may be considered a type of UCI (which may be referred to, for example, as artificial intelligence, machine learning (AIML) CSI). In some embodiments, AIML CSI may be obtained from a CSI report and measurement configurations with associated CSI-RS resources and report settings. In some embodiments, AIML CSI may be transmitted to a gNB via PUCCH or PUSCH (for example, following Rel-15 behavior). Thus, a format for a representation of feedback information for physical layer information may be established as a type of uplink UCI. A format may involve one or more types of coding (e.g., polar coding, low density parity check (LDPC) coding, and/or the like) which may depend, for example, on a type of physical channel used to transmit the UCI. In some embodiments, transmitting the type of uplink UCI (e.g., AIML CSI) with PUCCH may use polar coding, while transmitting with PUSCH may use LDPC coding. Moreover, before coding, the CSI may be quantized. Thus AIML CSI may be quantized to a bitstream (0s and 1s) and input to a polar coder or LDPC coder.

### Adaptability to Different Network Vendors

When a UE connects to a network, it may not know which network vendor created the network to which it is connected. Since different vendors may employ different training techniques and/or network architectures for machine learning models, the availability of this information may impact the training model at the UE side. Thus, in some embodiments, a network indication or an AI/ML index may be provided to a UE via system information (e.g., via one of the SIBs). The UE may then use this information to adapt its training to the specific network vendor configuration.

### ML Model Lifecycle Management

In some ML applications, the performance of an ML model may deteriorate over time, and may not perform adequately over the duration of an application it was trained for. Thus, an ML model may be updated frequently to adapt to temporal changes that may occur in its operating environment, e.g., statistical changes in the wireless channel in the case of CSI compression.

Some embodiments according to the disclosure may provide a management framework to enable efficient and/or timely updates of one or more ML models with acceptable overhead. To facilitate such a framework, one embodiment may implement model monitoring in which the node may keep track of the performance of the ML model. In some embodiments, this may involve model monitoring in which a node may track the performance of an ML model. Model monitoring may be based on one or more performance metrics as follows. (1) Task-based metrics may be used to assess (e.g., directly) the performance of a task being performed by an ML model. For example, these metrics can include accuracy, mean squared error (MSE) performance, and/or the like. (1) System-based metrics may be used to track the overall performance of the system, e.g., correct decoding of transmissions, or other system-level key performance indicators (KPIs) which may provide a less direct measure of the performance of an ML model used by a node in the system.

When the performance of an ML model is deemed unacceptable according to an agreed and/or configured metric, the management framework may initiate an ML model update procedure. Performance may be deemed unacceptable, for example, (1) when the ML model performance is not acceptable according to one or more agreed and/or configured metrics; and/or (2) if the performance of the ML model is not acceptable for a particular duration which is larger than a threshold time.

A threshold for determining unacceptable performance may be implemented as a configured and/or specified parameter. A time duration may be measured i) accumulatively, e.g., any duration of unacceptable performance may be added to a global counter, and the global counter value is compared to the threshold, or ii) contiguously, e.g., only a contiguous duration of unacceptable performance larger than a threshold may be considered.

When the performance of the ML model is deemed to be unacceptable, a management framework may trigger an update procedure that may be implemented in one of the following manners. (1) The management framework can require a full training procedure as described, for example, with respect to FIG. 8. In this case, the ML model may be re-trained from scratch, or it can be re-trained starting from the current ML model. Training in this case may use the entire training data set, with or without additional data samples that may have been acquired recently. (2) The management framework may require partial training in which the ML model may be re-trained starting from the current ML model and possibly using new data samples that have been acquired recently.

### Performance Metrics in Training and Testing

To evaluate the performance of different models for a CSI compression task, some embodiments according to the disclosure may focus on the aspect of CSI compression. In such an embodiment, different models may be compared based on their respective capability of compressing the CSI matrix and recovering the CSI matrix such that the recovered matrix is as close as possible to the true CSI matrix. A determination of closeness may be related to the operation of a gNB with the CSI matrix. For instance if a gNB calculates the SVD of the channel matrix as H_{r×t}=UΣV^{H} and uses the right singular vectors V to determine the pre-coder, closeness may be determined between the V at in the input of the encoder and the recovered V at the output of the decoder.

In some embodiments, a closeness metric between two matrices may be implemented on an element-wise basis, and the average may be taken over some or all elements to provide a single loss value. Alternatively, or additionally, having one or a few erroneous elements in the matrix may be as harmful as having many erroneous elements. In this case, the loss function may be determined on a matrix-wise basis, e.g., the maximum of element-wise errors over all the elements of the matrix.

In some embodiments, the performance of a CSI encoder and decoder model may also be evaluated in conjunction with other blocks of the system. For example, if a block error rate (BLER) is used as a system performance metric, the comparison between different CSI models may be based on their resulting BLER. Other system KPIs, such as throughput, resource utilization, etc., may also be used for this purpose.

In embodiments in which BLER is a metric of interest, configuring gNB to use the information provided by the CSI matrix may affect the system performance. For example, assuming a CSI model is perfect in the sense that a channel matrix sent by a UE is fully recovered at a gNB, and the channel matrix indicates a rank-1 channel, if the gNB schedules a rank-2 PDSCH, decoding may be likely to fail. Therefore, to establish a connection between a compression-capability of the CSI model and system performance, an assumption may be used regarding the gNB operation. In some embodiments, a gNB processing a function ƒ_{gNB} may be defined to take the output of the decoder, e.g., Ĥ, and provide an estimate of the resulting BLER as BLER=ƒ_{gNB}(Ĥ) (or BLER=ƒ_{gNB}(H, Ĥ)). The loss function during the training may then be defined considering both CSI compression and gNB operations aspects. For example, the loss may be defined as a weighted sum of the two terms as follows:

loss(H,Ĥ)=α·loss_{CSI}(H,Ĥ)+β·BLER (6)

where α and β are hyper-parameters for training.

### Reliability Aspects of Uplink Channel

In some embodiments, an output of the encoder, which may also be referred to as a CSI codeword, may be assumed to be available at the decoder side without error. Thus, the CSI codeword may be transmitted via PUCCH or PUSCH on an uplink channel with infinite reliability such that the PUCCH and/or PUSCH decoding does not fail. However, in some instances, in the inference phase, the CSI codeword may be delivered to the gNB (the decoder) with one or more errors, for example, when the PUSCH/PUCCH decoding fails. In such as case, a noisy version of the CSI codeword may be available at the decoder. The effects of imperfection in the uplink channel during the training phase may be modelled as follows.

For each training example input to the encoder, the CSI codeword at the output of the encoder may be denoted as x. Considering the imperfection of the uplink channel, the input to the decoder y may be modelled as

y=x+ω (7)

where ω is the additive noise that may model the residual error after the decoding of the uplink channel. The additive noise may be generated as follows in the training phase.

In Method 1, ω may be modelled as a Gaussian random vector with zero mean and variance σ². The variance may be indicated to the UE via RRC configuration or left to the UE implementation. In Method 2, the channel between x and y may be modelled by performing the PUCCH and/or PUSCH decoding for each training example, obtaining the residual error vector ω, and then assuming that the vector is added to x to obtain y.

### Federated Learning Aspects

With federated learning (FL), a global model at a server may learned by individual learnings at multiple nodes connected to the server and sharing the learned models with the server. The server then may perform one or more operations on the received models to obtain a final model. Such an arrangement may be motivated, for example, privacy aspects and/or requirements of the nodes to not share their data with the server.

With a CSI compression use case, the server may be considered to be the gNB and different UEs connected to the gNB may be considered as model updating nodes. Different UEs may have different training sets having the same or different distributions. If the distributions are the same, each UE may update the model with its own training set and share the model with the gNB. The gNB may then perform one or more operations, for example, averaging the models to obtain a final model. The gNB may share the obtained final model with the UEs which shared their models. The final model may be expected to outperform the individual received models as it is trained based on the union of all the training sets over all the participant UEs. Therefore, FL may be used to improve the CSI compression performance. In case of different distributions available at different UEs, FL may help to capture the distributions which have not yet been seen by specific UE through the models shared by UEs that have seen the distribution. In any case, FL can be used to obtain a model considering different environments observed by the UEs.

With an FL framework according to the disclosure, a gNB may configure a group of UEs to be in an FL group. The UEs in the same FL group may be configured to have the same encoder and/or decoder (e.g., auto-encoder or AE) architecture. Thus, their encoders and decoders may only be different in the actually trained weights but have the same configurations in terms of a number of layers, number of units, activation functions, and other parameters defining the network structure.

The size of the input to the encoder and the decoder models may be the same or similar for the UEs in the group. The input to the encoder may also have the same or similar meaning for the UEs. For example, the input to the encoders of the UEs (e.g., all the UEs) may be the channel matrix or the singular value matrix V. The gNB may indicate to the UEs via RRC, DCI or a MAC CE command to update their models and share the updates with the gNB. In some embodiments, not all the UEs in the group participate in the update procedure at the same time. The gNB may send information regarding training, hyperparameters and/or other aspects of the FL via a group-common (GC) DCI, where the UEs in the same FL group may have their specific portion of the DCI configured via RRC.

### Additional Embodiments

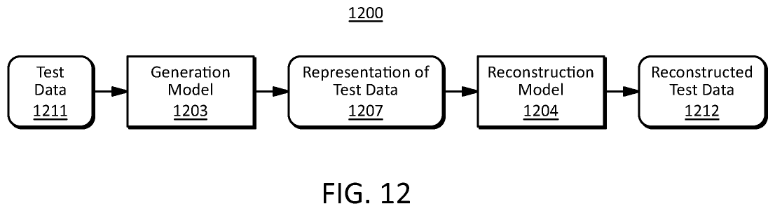

FIG. 12 illustrates an embodiment of a system for using a two-model scheme according to the disclosure. The embodiment illustrated in FIG. 12 may be described in the context of testing one or more of the models, but the same or similar embodiments may also be used for validation, inference, and/or the like, with any of the models disclosed herein, for example, with the generation model 303 and/or the reconstruction model 304 illustrated in FIG. 3 after training.

Referring to FIG. 12, the system 1200 may include a first node (Node 1) having a generation model 1203 and second node (Node B) having a reconstruction model 1204. Test data 1211 may be applied to the generation model 1203 which may generate a representation 1207 of the test data. The reconstruction model 1204 may generate a reconstruction 1212 of the test data based on the representation 1207 of the test data. In some embodiments, the generation model 1203 may include a quantizer to convert the representation 1207 to a quantized form (e.g., a bit stream) that may be transmitted through a communication channel. Similarly, in some embodiments, the reconstruction model 1204 may include a dequantizer that may convert a quantized representation 1207 (e.g., a bit stream) to a form that may be used to generate the reconstructed test data 1212.

The generation model 1203 and reconstruction model 1204 may be obtained in any manner including using any of the frameworks described herein. For example, using a joint training framework, the generation model 1203 and reconstruction model 1204 may be trained as a pair at Node A, which may transmit the reconstruction model 304 to Node B. Other embodiments may use a training framework with reference models, a training framework with latest shared values, or any other framework and/or technique to obtain and/or train the generation model 1203 and reconstruction model 1204.

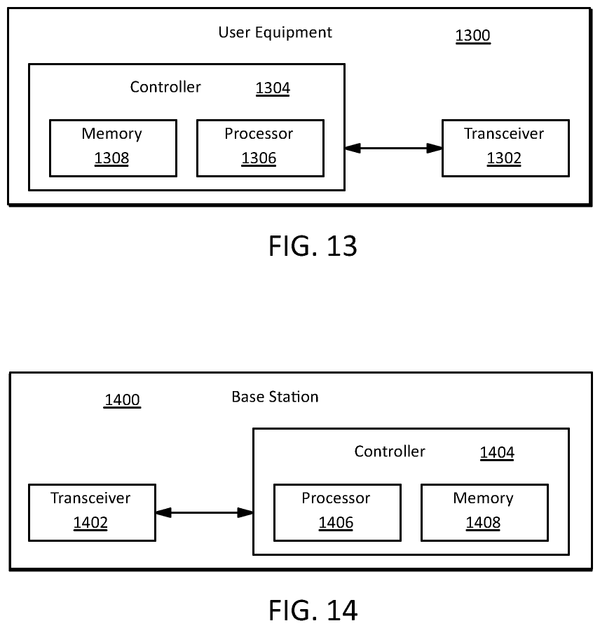

FIG. 13 illustrates an example embodiment of a user equipment (UE) in accordance with the disclosure. The embodiment 1300 illustrated in FIG. 13 may include a radio transceiver 1302 and a controller 1304 which may control the operation of the transceiver 1302 and/or any other components in the UE 1300. The UE 1300 may be used, for example, to implement any of the functionality described in this disclosure including determining channel information based on one or more reference signals from a base station, generating a representation of the channel information based on the condition of the channel using a machine learning model, sending the representation of the channel information, collecting training data, e.g., during a window, performing pre- and/or post-processing, e.g., for a CSI matrix, deploying and/or activating one or more pairs of ML models, and/or the like.

The transceiver 1302 may transmit/receive one or more signals to/from a base station, and may include an interface unit for such transmissions/receptions. For example, the transceiver 1302 may receive one or more signals from a base station and/or may transmit a representation of channel information to a base station on a UL channel.

The controller 1304 may include, for example, one or more processors 1306 and a memory 1308 which may store instructions for the one or more processors 1306 to execute code to implement any of the functionality described in this disclosure. For example, the controller 1304 may be configured to implement one or more machine learning models as disclosed herein, as well as determining channel information based on one or more reference signals from a base station, generating a representation of the channel information based on the condition of the channel using a machine learning model, sending the representation of the channel information, collecting training data, e.g., during a window, performing pre- and/or post-processing, e.g., for a CSI matrix, deploying and/or activating one or more pairs of ML models, and/or the like.

FIG. 14 illustrates an example embodiment of a base station in accordance with the disclosure. The embodiment 1400 illustrated in FIG. 14 may include a radio transceiver 1402 and a controller 1404 which may control the operation of the transceiver 1402 and/or any other components in the base station 1400. The base station 1400 may be used, for example, to implement any of the functionality described in this disclosure including transmitting one or more reference signals to a UE on a DL channel, reconstructing a representation of channel information, performing pre- and/or post-processing, e.g., for a CSI matrix, deploying and/or activating one or more pairs of ML models, and/or the like.

The transceiver 1402 may transmit/receive one or more signals to/from a user equipment, and may include an interface unit for such transmissions/receptions. For example, the transceiver 1402 may transmit one or more reference signals to a UE on a DL channel and/or receive receiving precoding information from a UE on a UL channel.

The controller 1404 may include, for example, one or more processors 1406 and a memory 1408 which may store instructions for the one or more processors 1406 to execute code to implement any of the base station functionality described in this disclosure. For example, the controller 1404 may be used to implement to implement one or more machine learning models as disclosed herein, as well as transmitting one or more reference signals to a UE on a DL channel, reconstructing a representation of channel information, performing pre- and/or post-processing, e.g., for a CSI matrix, deploying and/or activating one or more pairs of ML models, and/or the like.

In the embodiments illustrated in FIGS. 13 and 14, the transceivers 1302 and 1402 may be implemented with various components to receive and/or transmit RF signals such as amplifiers, filters, modulators and/or demodulators, A/D and/or DA converters, antennas, switches, phase shifters, detectors, couplers, conductors, transmission lines, and/or the like. The controllers 1304 and/or 1404 may be implemented with hardware, software, and/or any combination thereof. For example, full or partial hardware implementations may include combinational logic, sequential logic, timers, counters, registers, gate arrays, amplifiers, synthesizers, multiplexers, modulators, demodulators, filters, vector processors, complex programmable logic devices (CPLDs), field programmable gate arrays (FPGAs), application specific integrated circuits (ASICs), systems on chip (SOC), state machines, data converters such as ADCs and DACs, and/or the like. Full or partial software implementations may include one or more processor cores, memories, program and/or data storage, and/or the like, which may be located locally and/or remotely, and which may be programmed to execute instructions to perform one or more functions of the controllers. Some embodiments may include one or more processors such as microcontrollers, CPUs such as complex instruction set computer (CISC) processors such as x86 processors and/or reduced instruction set computer (RISC) processors such as ARM processors, and/or the like, executing instructions stored in any type of memory, graphics processing units (GPUs), neural processing units (NPUs), tensor processing units (TPUs), and/or the like.

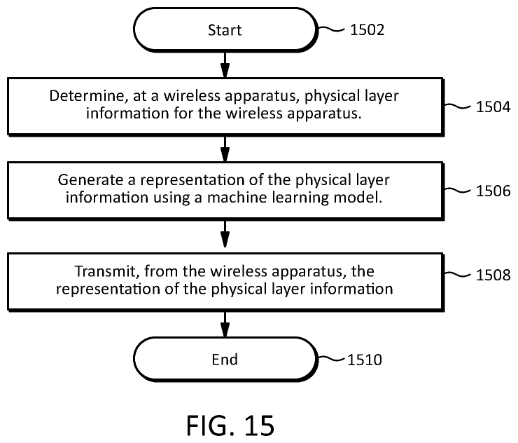

FIG. 15 illustrates an embodiment of a method for providing physical layer information feedback in accordance with the disclosure. The method may begin at operation 1502. At operation 1504, the method may determine, at a wireless apparatus, physical layer information for the wireless apparatus. At operation 1506, the method may generate a representation of the physical layer information using a machine learning model. At operation 1508, the method may transmit, from a user equipment, from the wireless apparatus, the representation of the physical layer information. The method may end at operation 1510.

In the embodiment illustrated in FIG. 15, and any of the embodiments disclosed herein, the illustrated components and/or operations are exemplary only. Some embodiments may involve various additional components and/or operations not illustrated, and some embodiments may omit some components and/or operations. Moreover, in some embodiments, the arrangement of components and/or temporal order of the operations may be varied. Although some components may be illustrated as individual components, in some embodiments, some components shown separately may be integrated into single components, and/or some components shown as single components may be implemented with multiple components.

The embodiments disclosed herein may be described in the context of various implementation details, but the principles of this disclosure are not limited to these or any other specific details. Some functionality has been described as being implemented by certain components, but in other embodiments, the functionality may be distributed between different systems and components in different locations. A reference to a component or element may refer to only a portion of the component or element. The use of terms such as “first” and “second” in this disclosure and the claims may only be for purposes of distinguishing the things they modify and may not indicate any spatial or temporal order unless apparent otherwise from context. A reference to a first thing may not imply the existence of a second thing. Moreover, the various details and embodiments described above may be combined to produce additional embodiments according to the inventive principles of this patent disclosure. Various organizational aids such as section headings and the like may be provided as a convenience, but the subject matter arranged according to these aids and the principles of this disclosure are not defined or limited by these organizational aids.

Since the inventive principles of this patent disclosure may be modified in arrangement and detail without departing from the inventive concepts, such changes and modifications are considered to fall within the scope of the following claims.

1. An apparatus comprising:
a receiver configured to receive a signal using a channel;
a transmitter configured to transmit a representation of channel information relating to the channel; and
at least one processor configured to:
determine a condition of the channel based on the signal; and
generate the representation of the channel information based on the condition of the channel using a machine learning model.

2. The apparatus of claim 1, wherein the at least one processor is configured to perform a selection of the machine learning model.

3. The apparatus of claim 2, wherein the at least one processor is configured to perform the selection of the machine learning model based on the condition of the channel.

4. The apparatus of claim 1, wherein the at least one processor is configured to activate the machine learning model based on model identification information received using the receiver.

5. The apparatus of claim 1, wherein the at least one processor is configured to receive the machine learning model.

6. The apparatus of claim 5, wherein the at least one processor is configured to receive a quantization function corresponding to the machine learning model.

7. The apparatus of claim 1, wherein the at least one processor is configured to train the machine learning model.

8. The apparatus of claim 7, wherein the at least one processor is configured to train the machine learning model using a quantization function.

9. The apparatus of claim 7, wherein the machine learning model is a generation model, and the at least one processor is configured to train the generation model using a reconstruction model that is configured to reconstruct the channel information based on the representation.

10. The apparatus of claim 9, wherein:
the generation model comprises an encoder; and
the reconstruction model comprises a decoder.

11. The apparatus of claim 9, wherein the at least one processor is configured to:
receive configuration information for the reconstruction model; and
train the generation model based on the configuration information.

12. The apparatus of claim 9, wherein the at least one processor is configured to perform joint training of the generation model and the reconstruction model.

13. The apparatus of claim 12, wherein the at least one processor is configured to send the reconstruction model based on the joint training.

14. The apparatus of claim 1, wherein the at least one processor is configured to collect training data for the machine learning model based on the channel.

15. The apparatus of claim 14, wherein the at least one processor is configured to collect the training data based on a resource window having a time dimension and a frequency dimension.

16. The apparatus of claim 1, wherein the at least one processor is configured to:
preprocess the channel information to generate transformed channel information; and
generate the representation of the channel information based on the transformed channel information.

17. The apparatus of claim 1, wherein the at least one processor is configured to train the machine learning model using a processing time.

18. The apparatus of claim 1, wherein the at least one processor is configured to send the representation of the channel information as link control information.

19. An apparatus comprising:
a transmitter configured to send a signal using a channel;
a receiver configured to receive a representation of channel information relating to the channel; and
at least one processor configured to construct the channel information based on the representation using a machine learning model.

20. A method comprising:
determining, at a wireless apparatus, physical layer information for the wireless apparatus;
generating a representation of the physical layer information using a machine learning model; and
transmitting, from the wireless apparatus, the representation of the physical layer information.
